(19) United States
(12) Patent Application Publication
(10) Pub. No.: US 2018/0025634 A1
(43) Pub. Date: Jan. 25, 2018

(54) VEHICLE GROUP MANAGEMENT APPARATUS, VEHICLE GROUP MANAGEMENT METHOD, COMPUTER READABLE MEDIUM, AND VEHICLE GROUP DISPLAY APPARATUS

(71) Applicant: Mitsubishi Electric Corporation, Tokyo (JP)

(72) Inventors: Junya UJIIE, Tokyo (JP); Kumiko IKEDA, Tokyo (JP); Akira HIRATA, Tokyo (JP); Mikio SASAKI, Tokyo (JP); Masahiro ABUKAWA, Tokyo (JP); Ryo OKABE, Tokyo (JP); Mitsuo SHIMOTANI, Tokyo (JP)

(73) Assignee: Mitsubishi Electric Corporation, Tokyo (JP)

(21) Appl. No.: 15/546,500

(22) PCT Filed: Mar. 12, 2015
(86) PCT No.: PCT/JP2015/057269

§ 371 Date: Jul. 26, 2017

(51) Int. Cl. G08G 1/0962; G08G 1/01; G08G 1/052

(52) U.S. Cl. CPC G08G 1/0962; G08G 1/052; G08G 1/0125

(57) ABSTRACT

The present invention relates to a vehicle group management apparatus, a vehicle group management method, and a vehicle group management program that manage a plurality of vehicles moving in line as a vehicle group, and the vehicle group management apparatus includes: a first management unit to manage vehicle information including position information indicating positions of a plurality of other-vehicles moving in line; and a calculation unit to calculate vehicle group information indicating the vehicle group including at least one of the other-vehicles, using a distance between other-vehicles based on the position information and a movement characteristic of an own-vehicle. Therefore, it is possible to provide an appropriate vehicle group in accordance with each vehicle.

### TECHNICAL FIELD

The present invention relates to a vehicle group management apparatus, a vehicle group management method, and a vehicle group management program that manage a plurality of vehicles moving in line as a vehicle group. Further, the present invention relates to a vehicle group display apparatus that displays the vehicle group.

### BACKGROUND ART

Conventionally, in order to prevent an accident of a vehicle, there is a technology for gathering information provided from a roadside apparatus or an other-vehicle through communication in addition to a sensor included in each vehicle, thereby notifying or warning a driver of an own-vehicle about the existence of the other-vehicle.

Patent Literature 1 discloses a method of gathering a position, a traveling direction, and a speed of a surrounding vehicle through vehicle-to-vehicle communication, thereby magnifying and displaying a region where information on the surrounding vehicle is gathered by a navigation apparatus of an own-vehicle.

Patent Literature 2 discloses a method of constituting a vehicle group from detected surrounding vehicles and calculating an area where an entry of an own-vehicle is not safe due to the vehicle group, thereby displaying the calculated area on the sight of a driver.

Patent Literature 3 discloses a method of defining, as interaction, a magnitude of influence on behaviors of other-vehicles by a behavior of each vehicle and estimating the interaction, thereby determining, as a vehicle group, a group of vehicles having predetermined interaction or more.

### CITATION LIST

### Patent Literature

Patent Literature 1: JP 2004-077281 A

Patent Literature 2: JP 2005-141557 A

Patent Literature 3: JP 2014-002477 A

### SUMMARY OF INVENTION

### Technical Problem

However, in Patent Literature 1, since the gathered information is displayed for each individual vehicle on a screen of the navigation apparatus, a driver needs to check a situation individually for each individual vehicle. Therefore, when the number of vehicles to be displayed is larger, it is difficult for the driver to understand each situation. In Patent Literature 1, in an attempt to solve this problem, display priority is set based on a degree of necessity of the driver's attention. However, information such that there is an other-vehicle behind a certain vehicle is important, for example, when merging onto a freeway, and the display priority should not be set low even if the other-vehicle is located far from the own-vehicle.

Patent Literature 2 attempts to solve the problem of Patent Literature 1 by providing information to a driver as the vehicle group rather than as an individual vehicle. However, in Patent Literature 2, in a case where there are a plurality of vehicles entering an intersection point from the same direction, the plurality of vehicles are defined as the vehicle group. For example, even when inter-vehicle distances of the plurality of vehicles are sufficiently large, the plurality of vehicles might be defined as one vehicle group, and an appropriate vehicle group might not be defined.

As with Patent Literature 2, Patent Literature 3 also attempts to solve the problem of Patent Literature 1 by providing information to a driver as the vehicle group rather than as an individual vehicle. However, in determining the vehicle group, a problem arises that a specification and state of an own-vehicle are not considered. For example, in a case where the driver of the own-vehicle executes a driving action in response to the vehicle group, an appropriate vehicle group might not be defined unless various characteristics on the own-vehicle side are considered.

The present invention aims, for example, to solve a problem described above, and to provide a vehicle group in accordance with each vehicle.

### Solution to Problem

A vehicle group management apparatus according to the present invention includes: a first management unit to manage vehicle information including position information indicating positions of a plurality of other-vehicles moving in line; and a calculation unit to calculate vehicle group information indicating a vehicle group including at least one of the other-vehicles, using a distance between the other-vehicles based on the position information and a movement characteristic of an own-vehicle.

A vehicle group management method according to the present invention includes: a first management step to manage vehicle information including position information indicating positions of a plurality of other-vehicles moving in line; and a calculation step to calculate vehicle group information indicating a vehicle group including at least one of the other-vehicles, using a distance between the other-vehicles based on the position information and a movement characteristic of an own-vehicle.

A vehicle group management program according to the present invention for a computer to function as: a first management unit to manage vehicle information including position information indicating positions of a plurality of other-vehicles moving in line; and a calculation unit to calculate vehicle group information indicating a vehicle group including at least one of the other-vehicles, using a distance between the other-vehicles based on the position information and a movement characteristic of an own-vehicle.

A vehicle group display apparatus according to the present invention includes: a communication unit to receive image data indicating a vehicle group including at least one of other-vehicles, the vehicle group being specified in accordance with a distance between the other-vehicles that are a plurality of other-vehicles moving in line and a movement characteristic of an own-vehicle; and a display unit to display the image data received by the communication unit.

### ADVANTAGEOUS EFFECTS OF INVENTION

According to the vehicle group management apparatus of the present invention, it is possible to provide an appropriate vehicle group in accordance with each vehicle.

According to the vehicle group management method of the present invention, it is possible to provide an appropriate vehicle group in accordance with each vehicle.

According to the vehicle group management program of the present invention, it is possible to provide an appropriate vehicle group in accordance with each vehicle.

According to the vehicle group display apparatus of the present invention, it is possible to provide an appropriate vehicle group in accordance with each vehicle.

### BRIEF DESCRIPTION OF DRAWINGS

FIG. 1 is a configuration diagram illustrating an example of a vehicle group management apparatus 10 and a vehicle group display apparatus 20 according to a first embodiment.

FIG. 2 is a hardware configuration diagram illustrating an example of hardware configurations of the vehicle group management apparatus 10 and the vehicle group display apparatus according to the first embodiment.

FIG. 3 is a diagram illustrating an example of a configuration of vehicle information 2 according to the first embodiment.

FIG. 4 is a diagram illustrating a positional relation between an own-vehicle and other-vehicles according to the first embodiment.

FIG. 5 is a flowchart illustrating an operation at a time when the vehicle group management apparatus 10 according to the first embodiment transmits the vehicle information 2.

FIG. 6 is a diagram illustrating an example of a configuration of vehicle group information 3 according to the first embodiment.

FIG. 7 is a flowchart illustrating an operation at a time when the vehicle group management apparatus 10 according to the first embodiment receives the vehicle information 2.

FIG. 8 is a diagram illustrating an example of image data displayed by the display unit 202 according to the first embodiment.

FIG. 9 is a diagram illustrating an example of the image data displayed by the display unit 202 according to the first embodiment.

FIG. 10 is a diagram illustrating an example of a configuration of vehicle information 2a according to the first embodiment.

FIG. 11 is a configuration diagram illustrating an example of a vehicle group management apparatus 10a and the vehicle group display apparatus 20 according to a second embodiment.

FIG. 12 is a flowchart illustrating an operation at a time when the vehicle group management apparatus 10a according to the second embodiment receives the vehicle information.

FIG. 13 is a configuration diagram illustrating an example of a vehicle group management apparatus 10b and the vehicle group display apparatus 20 according to a third embodiment.

FIG. 14 is a flowchart illustrating an operation at a time when the vehicle group management apparatus 10b according to the third embodiment classifies a driving situation.

FIG. 15 is a configuration diagram illustrating an example of a vehicle group management apparatus 10c and the vehicle group display apparatus 20 according to a fourth embodiment.

FIG. 16 is a diagram illustrating a positional relation between an own-vehicle and other-vehicles according to the fourth embodiment.

FIG. 17 is a flowchart illustrating an operation at a time when the vehicle group management apparatus 10c according to the fourth embodiment displays a vehicle group.

FIG. 18 is a configuration diagram illustrating an example of a vehicle group management apparatus 10d and the vehicle group display apparatus 20 according to a fifth embodiment.

FIG. 19 is a flowchart illustrating an operation at a time when the vehicle group management apparatus 10d according to the fifth embodiment transmits the vehicle information 2.

### DESCRIPTION OF EMBODIMENTS

Hereinafter, in order to describe the present invention in more detail, embodiments of the present invention will be described. Note that, the embodiments below are examples of the present invention, and the present invention is not limited to the embodiments below. Further, in the description below, a vehicle is not limited to a four-wheeled vehicle, but also includes a two-wheeled vehicle and the like.

### First Embodiment

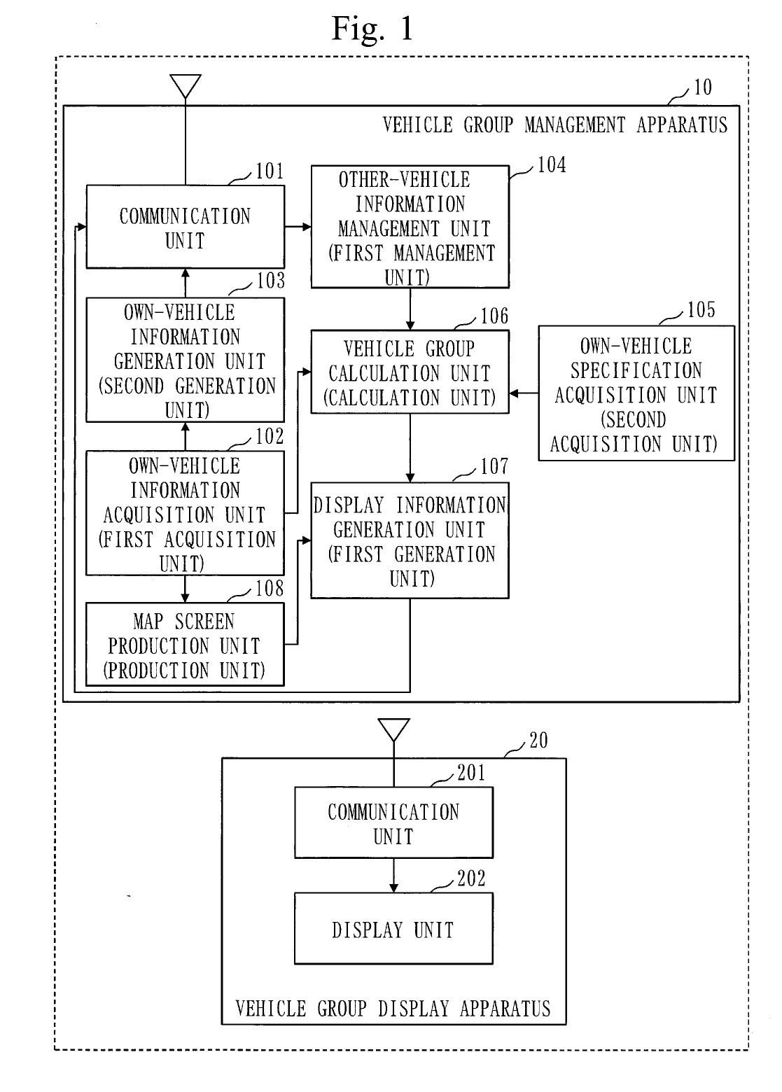

FIG. 1 is a configuration diagram illustrating an example of a vehicle group management apparatus 10 and a vehicle group display apparatus 20 according to a first embodiment indicating an embodiment of the present invention.

In FIG. 1, the vehicle group management apparatus 10 includes a communication unit 101, an own-vehicle information acquisition unit 102, an own-vehicle information generation unit 103, an other-vehicle information management unit 104, an own-vehicle specification acquisition unit 105, a vehicle group calculation unit 106, a display information generation unit 107, and a map screen production unit 108.

Further, the vehicle group display apparatus 20 includes a communication unit 201 and a display unit 202.

Note that, the own-vehicle information acquisition unit 102 corresponds to a first acquisition unit. The own-vehicle information generation unit 103 corresponds to a second generation unit. The other-vehicle information management unit 104 corresponds to a first management unit. The own-vehicle specification acquisition unit 105 corresponds to a second acquisition unit. The vehicle group calculation unit 106 corresponds to a calculation unit. The display information generation unit 107 corresponds to a first generation unit. The map screen production unit 108 corresponds to a production unit.

The communication unit 101 of the vehicle group management apparatus 10 is a device that transmits/receives data to/from a communication device and the vehicle group display apparatus 20 located outside the vehicle group management apparatus 10.

The own-vehicle information acquisition unit 102 is a device that gathers information on a state of an own-vehicle such as the number of passengers and a weight of the own-vehicle, information on a driving operation of the own-vehicle such as an accelerator, a steering wheel, and a direction indicator, information on a movement of the own-vehicle such as vehicle speed and acceleration, and position information on a position of the own-vehicle such as a current position, and the like. The own-vehicle information acquisition unit 102 is, for example, realized as a CAN (Controller Area Network).

The own-vehicle information generation unit 103 is a device that generates vehicle information 2 using information obtained from the own-vehicle information acquisition unit 102. The vehicle information 2 will be described below.

The other-vehicle information management unit 104 is a device that manages the vehicle information 2 of an other-vehicle obtained via the communication unit 101. The vehicle information 2 is stored in the other-vehicle information management unit 104.

The own-vehicle specification acquisition unit 105 is a device that acquires a specification indicating static performance of a vehicle on which the vehicle group management apparatus 10 is mounted. The own-vehicle specification acquisition unit 105 is, for example, realized as a storage device. Alternatively, the own-vehicle specification acquisition unit 105 is realized as an interface that acquires the specification from a device in a vehicle different from the vehicle group management apparatus 10.

The vehicle group calculation unit 106 is a device that calculates vehicle group information indicating a vehicle group including at least one of the other-vehicles, using a distance between other-vehicles based on position information indicating positions of a plurality of other-vehicles moving in line and a movement characteristic of the own-vehicle. Note that, the position information is included in the vehicle information 2 managed by the other-vehicle information management unit 104. Further, the movement characteristic of the own-vehicle is a characteristic affecting the movement of the own-vehicle, and is the information gathered by the own-vehicle information acquisition unit 102, and the information acquired by the own-vehicle specification acquisition unit 105.

Here, the vehicle group information is calculated using the vehicle information 2 of the other-vehicle managed by the other-vehicle information management unit 104, the information acquired by the own-vehicle information acquisition unit 102, and the specification acquired by the own-vehicle specification acquisition unit 105.

The display information generation unit 107 is a device that generates image data indicating the vehicle group, using the vehicle group information calculated by the vehicle group calculation unit 106. Note that, the generated image data is transmitted to the vehicle group display apparatus 20 and displayed by the display unit 202.

The map screen production unit 108 is a device that stores map data and produces a map screen using the map data and the position information on the own-vehicle acquired by the own-vehicle information acquisition unit 102.

The communication unit 201 of the vehicle group display apparatus 20 is a device that transmits/receives data to/from the vehicle group management apparatus 10. Here, the communication unit 201 receives the image data generated by the display information generation unit 107.

The display unit 202 is a device that displays the image data received by the communication unit 201. For example, the display unit 202 is a display device such as a display. Here, in the image data, the vehicle group calculated by the vehicle group calculation unit 106 is shown on the map screen produced by the map screen production unit 108.

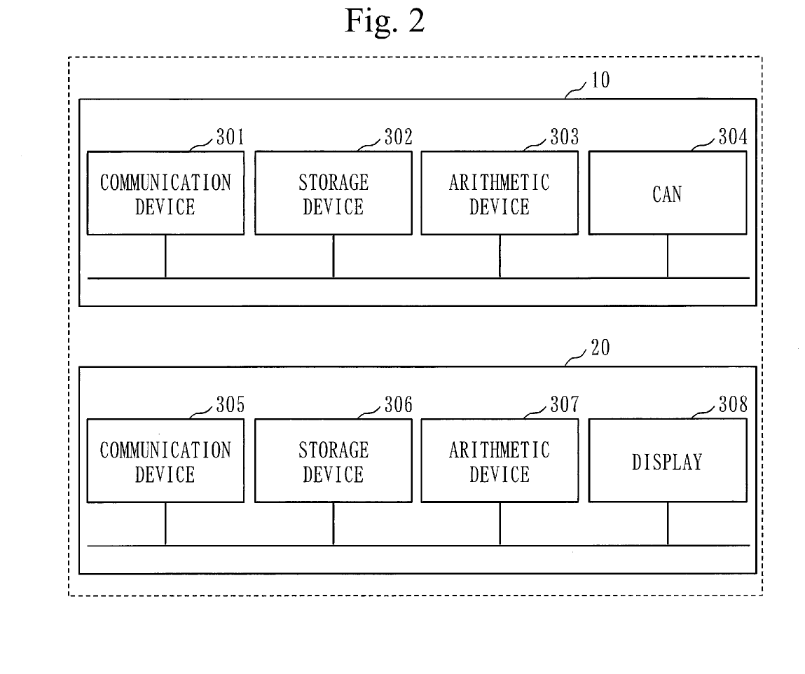

FIG. 2 is a hardware configuration diagram illustrating an example of hardware configurations of the vehicle group management apparatus 10 and the vehicle group display apparatus according to the first embodiment indicating an embodiment of the present invention.

In FIG. 2, the vehicle group management apparatus 10 includes a communication device 301, a storage device 302, an arithmetic device 303, and a CAN 304. Further, the vehicle group display apparatus 20 includes a communication device 305, a storage device 306, an arithmetic device 307, and a display 308.

The communication device 301 corresponds to the communication unit 101, and is configured with a wireless communication device such as a BLUETOOTH (registered trademark), a wireless LAN (Local Area Network) adaptor, or the like. Further, the transmission/reception of data to/from the vehicle group display apparatus 20 may be realized using wired communication.

The storage device 302 stores a program and data for realizing each function of the own-vehicle information generation unit 103, the other-vehicle information management unit 104, the own-vehicle specification acquisition unit 105, the vehicle group calculation unit 106, the display information generation unit 107, and the map screen production unit 108. Further, the storage device 302 is, for example, configured with a ROM (Read Only Memory), a RAM (Random Access Memory), a HDD (Hard Disk Drive), or a SSD (Solid State Drive).

The arithmetic device 303 reads out the program and data stored in the storage device 302 as needed, and realizes each function of the own-vehicle information generation unit 103, the other-vehicle information management unit 104, the own-vehicle specification acquisition unit 105, the vehicle group calculation unit 106, the display information generation unit 107, and the map screen production unit 108.

The CAN 304 corresponds to the own-vehicle information acquisition unit 102.

The communication device 305 corresponds to the communication unit 201, and is configured with a wireless communication device such as a BLUETOOTH (registered trademark), a wireless LAN (Local Area Network) adaptor, or the like. Further, the communication device 305 may be realized using wired communication.

The storage device 306 stores a program and data for realizing a function of the display unit 202. The storage device 306 also stores the image data as data. Further, the storage device 306 is, for example, configured with a ROM (Read Only Memory), a RAM (Random Access Memory), a HDD (Hard Disk Drive), or a SSD (Solid State Drive).

The arithmetic device 307 reads out the program and data stored in the storage device 302 as needed, and realizes the function of the display unit 202.

The display 308 corresponds to the display unit 202, and for example, is configured with a liquid crystal or a LED (Light Emitting Diode).

As described above, the display unit 202 is realized by the storage device 306, the arithmetic device 307, and the display 308.

Note that, a plurality of processing circuits may be configured to cooperatively realize functions of the communication unit 101, the own-vehicle information acquisition unit 102, the own-vehicle information generation unit 103, the other-vehicle information management unit 104, the own-vehicle specification acquisition unit 105, the vehicle group calculation unit 106, the display information generation unit 107, the map screen production unit 108, the communication unit 201, and the display unit 202.

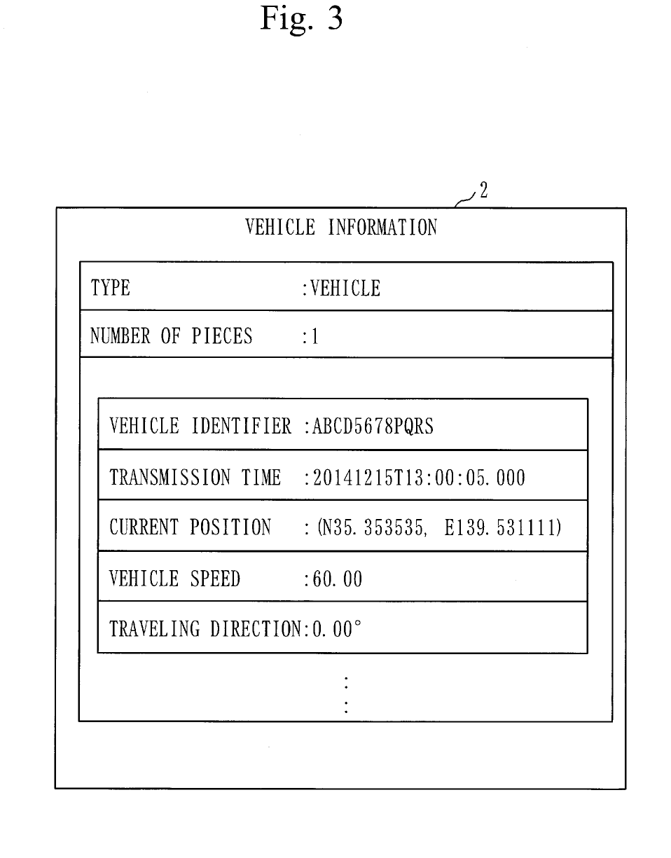

FIG. 3 is a diagram illustrating an example of a configuration of the vehicle information 2 according to the present embodiment.

The vehicle information 2 has information indicating a type and the number of pieces at the top. These mean a type and the number of pieces of following information from a vehicle identifier to a traveling direction which are treated as one set. In FIG. 3, although the information indicating the vehicle identifier, a transmission time, a current position, a vehicle speed, and the traveling direction is included, any other item may be included.

The vehicle identifier is information for uniquely identifying a vehicle on which the vehicle group management apparatus 10 is mounted, or information for uniquely identifying the vehicle group management apparatus 10 itself. The transmission time is information indicating a time at which the vehicle group management apparatus 10 has transmitted the vehicle information 2. The current position is information indicating a position at a time point when the vehicle group management apparatus 10 has transmitted the vehicle information 2, and is obtained from the own-vehicle information acquisition unit 102. The vehicle speed is information indicating a speed of the vehicle on which the vehicle group management apparatus 10 is mounted at the time point when the vehicle group management apparatus 10 has transmitted the vehicle information 2, and obtained from the own-vehicle information acquisition unit 102. The traveling direction is information indicating a direction to which the vehicle on which the vehicle group management apparatus 10 is mounted moves at the time point when the vehicle group management apparatus 10 has transmitted the vehicle information 2, and obtained from the own-vehicle information acquisition unit 102. A value of each item indicated in FIG. 3 is an example, and may be in a different format as long as it is interpretable by the vehicle group management apparatus 10 mounted on each vehicle.

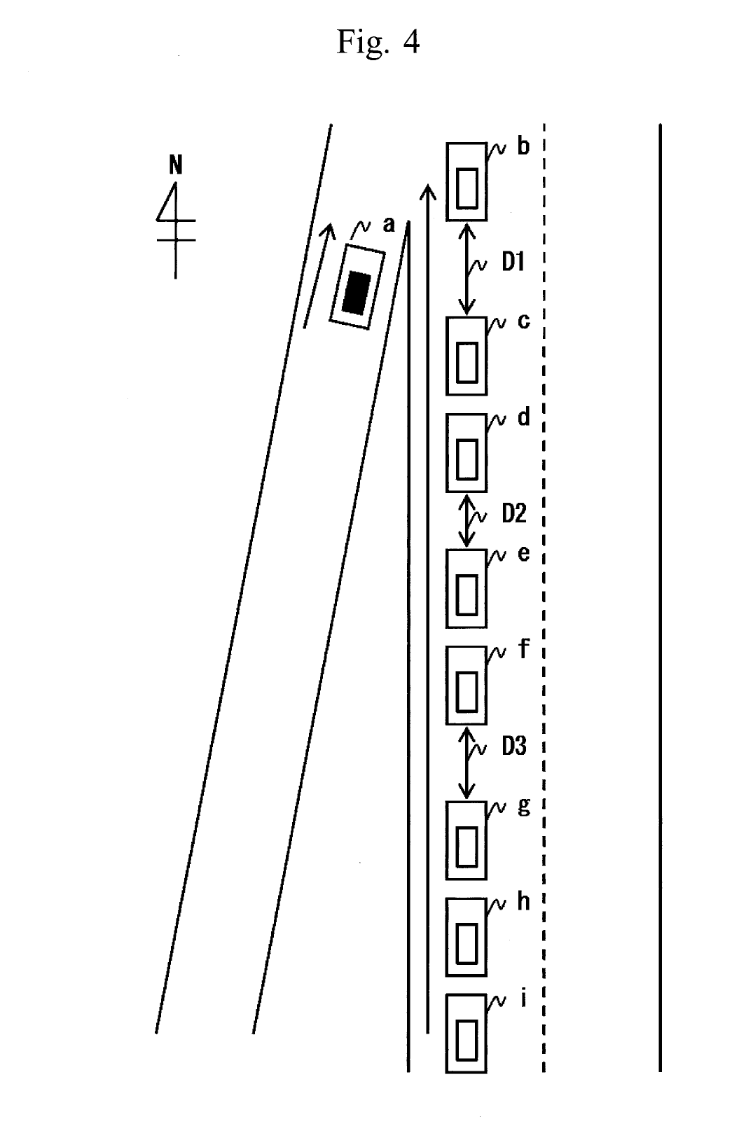

FIG. 4 is a diagram illustrating a positional relation between the own-vehicle and the other-vehicles according to the present embodiment.

In FIG. 4, each of arrows on the left side of an own-vehicle a and other-vehicles b to i means traveling direction. That is, FIG. 4 illustrates a situation where the own-vehicle a is about to enter a lane in which the other-vehicles b to i are running. Further, it is assumed that an inter-vehicle distance between the other-vehicle b and the other-vehicle c is D1, an inter-vehicle distance between the other-vehicle d and the other-vehicle e is D2, and an inter-vehicle distance between the other-vehicle f and the other-vehicle g is D3. Note that, in the following description, it is assumed that all of the own-vehicle a and the other-vehicles b to i mount the vehicle group management apparatus 10.

Nextly, operations of the vehicle group management apparatus 10 and the vehicle group display apparatus 20 will be described, and processing operations of a vehicle group management method and a vehicle management program will also be described.

Note that, the operation will be described separately for a time of transmitting vehicle information and for a time of receiving vehicle information.

Firstly, the operation at the time of transmitting the vehicle information 2 will be described with reference to FIGS. 1, 3, and 5.

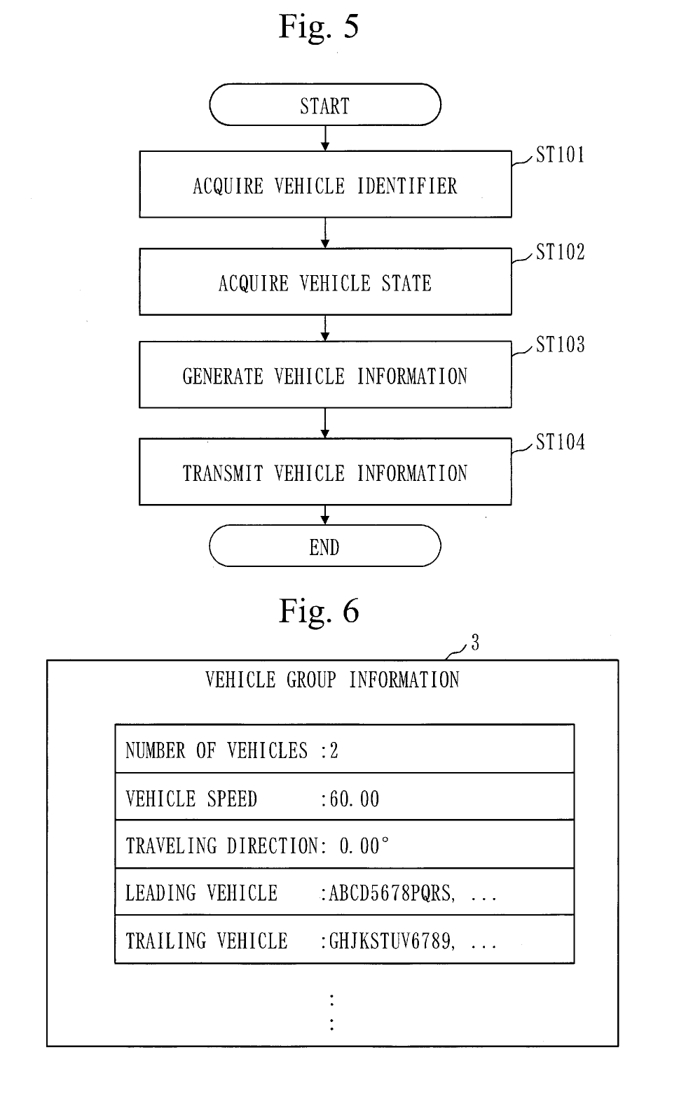

FIG. 5 is a flowchart illustrating the operation at the time when the vehicle group management apparatus 10 according to the present embodiment transmits the vehicle information 2.

Note that, the transmission of the vehicle information 2 is executed periodically, and FIG. 5 illustrates the operation for one cycle.

(ST101): The own-vehicle information generation unit 103 acquires the vehicle identifier. The vehicle identifier is, for example, stored in the own-vehicle specification acquisition unit 105, and the own-vehicle information generation unit 103 acquires the vehicle identifier from the own-vehicle specification acquisition unit 105. Note that, this process may be executed once after activating the vehicle group management apparatus 10, and thereafter, a value stored in the own-vehicle information generation unit 103 may be used.

(ST102): The own-vehicle information generation unit 103 acquires the current position, the vehicle speed, and the traveling direction from the own-vehicle information acquisition unit 102.

(ST103): The own-vehicle information generation unit 103 generates the vehicle information 2 using the information acquired in ST101 and ST102. At this time, “vehicle” is set for the type, and 1 is set for the number of pieces. Further, time information acquirable by the vehicle group management apparatus 10 is set for the transmission time. Note that, in the present embodiment, it is assumed that the vehicle group management apparatus 10 has been time-synchronized with a vehicle group management apparatus other than itself, using information on a time obtained from the outside of the vehicle, for example, a GPS signal (a Global Positioning System signal).

(ST104): The communication unit 101 transmits the vehicle information 2 generated in ST103.

Nextly, the operation at the time of receiving the vehicle information 2 will be described with reference to FIGS. 1, 3, 6, and 7.

FIG. 6 is a diagram illustrating an example of a configuration of vehicle group information 3 according to the present embodiment.

Note that, the vehicle group information 3 is produced by the vehicle group calculation unit 106 and is passed to the display information generation unit 107.

Although the vehicle group information 3 has information indicating the number of vehicles, a vehicle speed, a traveling direction, a leading vehicle, and a trailing vehicle, any other item may be included.

The number of vehicle is information indicating the number of vehicles belonging to the vehicle group. The vehicle speed is a value obtained from vehicle speeds of vehicles belonging to the vehicle group, and for example, an average value or a maximum value is used. Like the vehicle speed, the traveling direction is also a value obtained from traveling directions of the vehicles belonging to the vehicle group. The leading vehicle is information indicating the vehicle information 2 as to a vehicle corresponding to a front of the vehicle group. The trailing vehicle is information indicating the vehicle information 2 as to a vehicle corresponding to an end of the vehicle group. In FIG. 6, although only vehicle identifiers are described in the columns of the leading vehicle and the trailing vehicle, other items are actually included. A value of each item indicated in FIG. 6 is an example, and may be in a different format as long as it is interpretable by the vehicle group management apparatus 10 mounted on each vehicle.

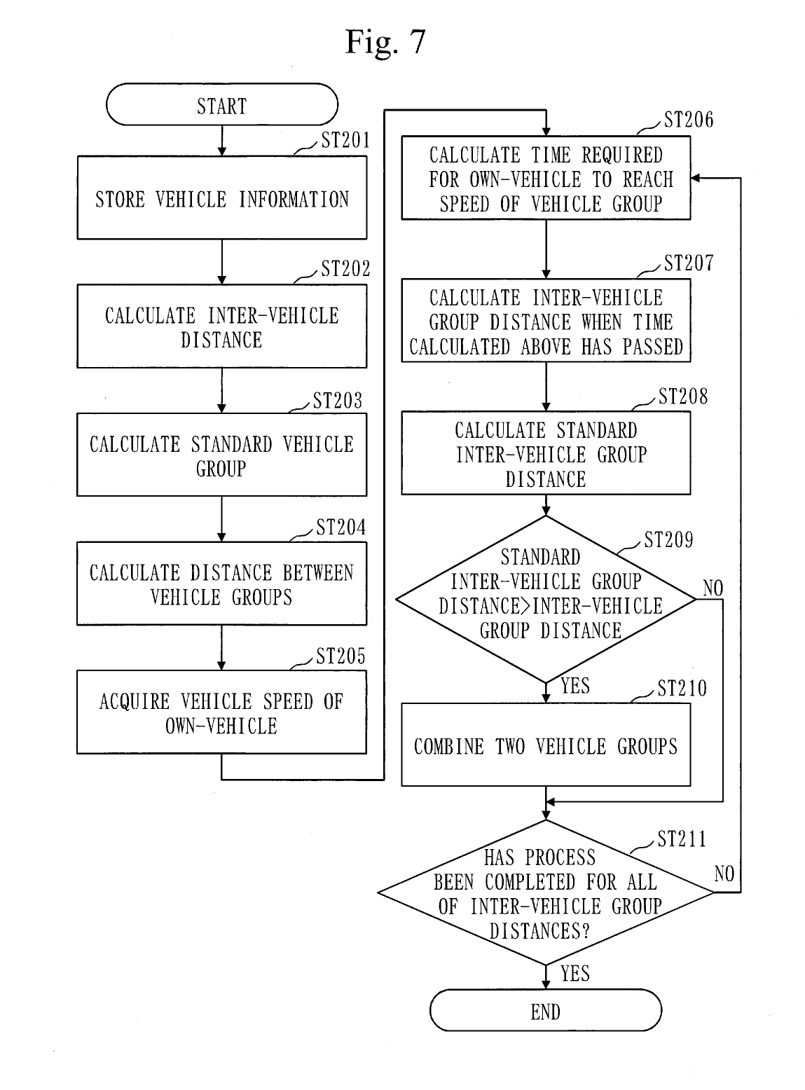

FIG. 7 is a flowchart illustrating the operation at the time when the vehicle group management apparatus 10 according to the present embodiment receives the vehicle information 2.

(ST201): When the communication unit 101 receives the vehicle information 2, the communication unit 101 passes the vehicle information 2 to the other-vehicle information management unit 104. The other-vehicle information management unit 104 stores the passed vehicle information 2. For example, based on the vehicle identifier of the vehicle information 2, when there exists vehicle information 2 having the same vehicle identifier, the other-vehicle information management unit 104 overwrites the vehicle information 2 with the passed vehicle information 2 and stores the passed vehicle information 2. When there does not exist the vehicle information 2 having the same vehicle identifier, the other-vehicle information management unit 104 newly stores the passed vehicle information 2.

(ST202): Upon the arrival of the new vehicle information 2 at the other-vehicle information management unit 104, the vehicle group calculation unit 106 calculates, based on the current position of each vehicle information, an inter-vehicle distance between vehicles which are adjacent to each other.

(ST203): The vehicle group calculation unit 106 calculates a standard vehicle group. For example, using standard inter-vehicle distance data indicating a relationship between vehicle speeds of two vehicles and a standard inter-vehicle distance between the two vehicles, the vehicle group calculation unit 106 compares the standard inter-vehicle distance based on that data with the inter-vehicle distance calculated in ST202. When the latter is longer, the two vehicles are assumed to belong to the same vehicle group. Then, based on that result, the vehicle group information 3 is produced or updated. Note that, the standard inter-vehicle distance data is, for example, static data embedded in the vehicle group calculation unit 106.

Note that, in a case of updating, the number of vehicles, the vehicle speed, and the traveling direction are necessarily changed, and either one of the leading vehicle and trailing vehicle is updated. For example, when this process is started from the leading vehicle based on the traveling direction, the trailing vehicle is updated every time. Note that, although not illustrated, when the number of vehicle groups is 1 as a result of executing ST203, the process from ST204 onwards is not performed.

(ST204): Using two or more pieces of vehicle group information 3 produced or updated in ST203, the vehicle group calculation unit 106 calculates an inter-vehicle group distance between vehicle groups which are adjacent to each other.

(ST205): The vehicle group calculation unit 106 acquires the vehicle speed of the own-vehicle from the own-vehicle information acquisition unit 102.

(ST206): ST206 to ST210 is a process being repeatedly performed the number of vehicle groups-1 times, and is performed starting from a second vehicle group from a leading vehicle group. In ST206, firstly, the vehicle group calculation unit 106 determines a time period required for the own-vehicle to reach the same speed as the vehicle group, using the vehicle speed described in the vehicle group information 3 and the vehicle speed of the own-vehicle. For example, the vehicle group calculation unit 106 uses information on the specification stored in the own-vehicle specification acquisition unit 105. The own-vehicle specification acquisition unit 105 stores the specification indicating a time period required to reach a target vehicle speed from a current vehicle speed. This specification is stored, for example, as a unique table to each vehicle, whose horizontal axis indicates current vehicle speeds, whose vertical axis indicates target vehicle speeds and whose intersection part has a numerical value indicating a time period to reach each of the target vehicle speeds. The vehicle group calculation unit 106 is able to determine the time period required for the own-vehicle to reach the same speed as the vehicle group by inquiring the own-vehicle specification acquisition unit 105.

Nextly, the vehicle group calculation unit 106 adjusts the time period required for the own-vehicle to reach the same speed as the vehicle group. For example, the vehicle group calculation unit 106 uses a weight Wb of the vehicle stored in the own-vehicle specification acquisition unit 105 as the specification and an actual weight Wa acquired by the vehicle information acquisition unit 102. The vehicle group calculation unit 106 acquires the weight Wb of the vehicle from the own-vehicle specification acquisition unit 105, and acquires the actual weight Wa from the vehicle information acquisition unit 102. Then, a value obtained by dividing the weight Wa by the weight Wb is multiplied by the time period required for the own-vehicle to reach the same speed as the vehicle group, so that the time period previously obtained is adjusted. By adjusting in this manner, it is possible to improve the accuracy of the time period required for the own-vehicle to reach the same speed as the vehicle group.

(ST207): The vehicle group calculation unit 106 calculates an inter-vehicle group distance at a time when the time period calculated last in ST206 has passed. For example, using the information included in the vehicle group information 3, the vehicle group calculation unit 106 multiples a difference between a vehicle speed of a preceding vehicle group and a vehicle speed of a following vehicle group by the time period calculated last in ST206, so that an amount of change of an inter-vehicle group distance is calculated. Then, that amount of change is added to a current inter-vehicle group distance, so that the inter-vehicle group distance at the time when the time period calculated last in ST206 has passed is calculated.

(ST208): The vehicle group calculation unit 106 calculates a standard inter-vehicle group distance. For example, the vehicle group calculation unit 106 calculates the standard inter-vehicle group distance corresponding to the vehicle speed of each vehicle group included in the vehicle group information 3, using standard inter-vehicle group distance data indicating a relationship between the vehicle speeds of the two vehicle groups and the standard inter-vehicle group distance between the two vehicle groups.

(ST209): The vehicle group calculation unit 106 determines whether or not the inter-vehicle group distance calculated in ST207 is shorter than the standard inter-vehicle group distance calculated in ST208. If it is shorter (Yes), the process proceeds to ST210. If it is equal or longer (No), the process proceeds to ST211.

(ST210): The vehicle group calculation unit 106 combines pieces of vehicle group information 3 corresponding to the two vehicle groups focused in ST209.

(ST211): The vehicle group calculation unit 106 determines whether or not the processes from ST206 to ST210 have been completed for all of vehicle groups to be processed. If completed (Yes), the process ends. If not completed (No), the processes from ST206 start for a next vehicle group.

When the vehicle group calculation unit 106 has completed the generation of the vehicle group information 3, the display information generation unit 107 generates, using that vehicle group information, the image data indicating the vehicle group. The image data generated by the display information generation unit 107 is passed to the communication unit 101. The communication unit 101 transmits the received image data to the vehicle group display apparatus 20.

Note that, in the present embodiment, in the image data, the vehicle group is overlaid and displayed on the map screen produced by the map screen production unit 108.

The map screen production unit 108 produces the map screen using the map data stored therein and the position information on the own-vehicle acquired by the own-vehicle information acquisition unit 102.

The display information generation unit 107 receives the map screen from the map screen production unit 108 and also receives the vehicle group information 3 from the vehicle group calculation unit 106. Then, the display information generation unit 107 generates the image data in which the vehicle group is overlaid and displayed on the map screen, by collating information on a positon in the map data associated with that map screen with the current position of the vehicle included in the vehicle group included in the vehicle group information 3.

When the image data is transmitted from the vehicle group management apparatus 10, the communication unit 201 of the vehicle group display apparatus 20 receives that image data. The received image data is stored in the display unit 202 and displayed by the display unit 202.

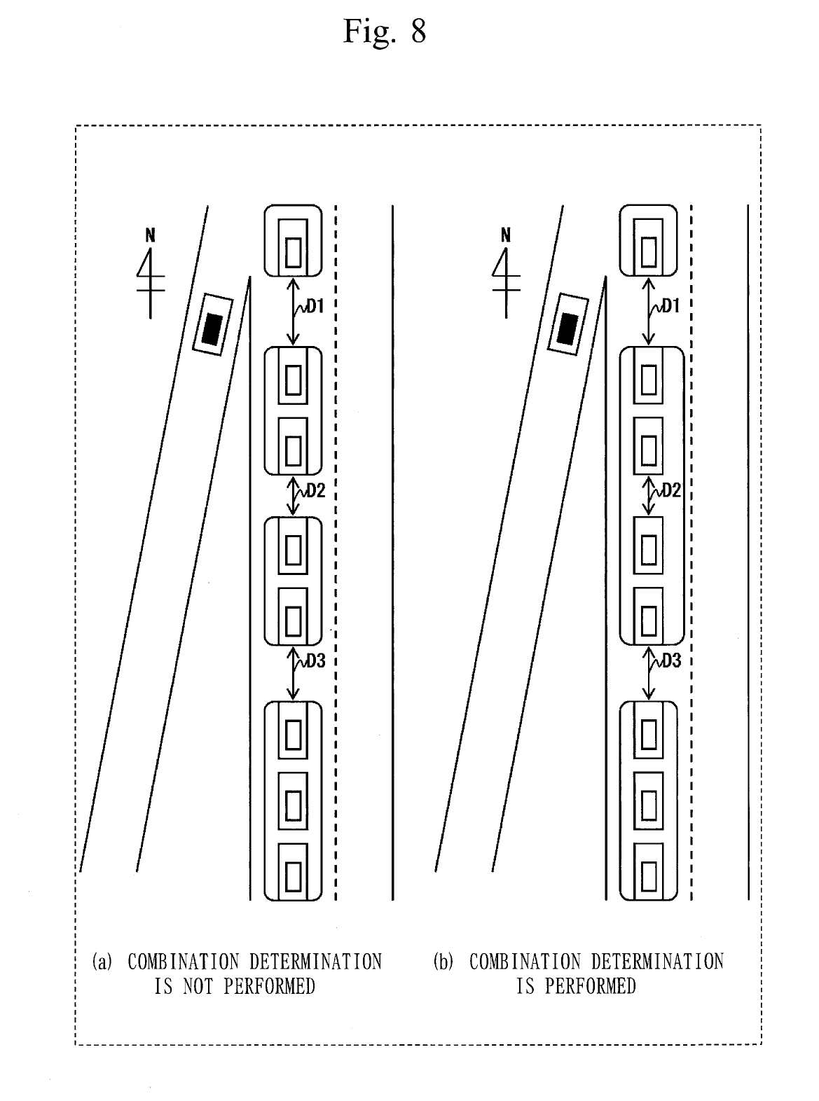

FIG. 8 is a diagram illustrating an example of the image data displayed by the display unit 202 according to the present embodiment.

In FIG. 8, a positional relation between the own-vehicle and the other-vehicles is the same as that in FIG. 4. Note that, images meaning the other-vehicles and the inter-vehicle group distances D1, D2, and D3 are illustrated for explanation, but they may not appear on the screen shown to the driver.

FIG. 8 (a) is a display example in a case where the combination determination (ST204 to ST211 in FIG. 7) to the vehicle groups described in the present embodiment is not performed. That is, FIG. 8 (a) illustrates standard vehicle groups which are obtained by using the standard inter-vehicle distances. All of the inter-vehicle group distances D1, D2, and D3 are longer than the inter-vehicle distance being a reference. As a result, four vehicle groups are displayed.

FIG. 8 (b) is a display example in a case where the combination determination to the vehicle groups described in the present embodiment is performed. Here, the inter-vehicle group distance D2 should not be merged in view of the specification and state of the own-vehicle. That is, it is determined that the inter-vehicle group distance is short and the preceding and following vehicle groups are combined. As a result, three vehicle groups are displayed.

As described above, in the present embodiment, the vehicle group management apparatus 10 receives from the other-vehicle the vehicle information 2 using the communication unit 101, accumulates the vehicle information 2 in the other-vehicle information management unit 104, and in the vehicle group calculation unit 106, calculates the vehicle group using information from the own-vehicle information acquisition unit 102, the other-vehicle information management unit 104, and the own-vehicle specification acquisition unit 105. Then, it is determined whether or not to combine the vehicle groups which are adjacent to each other using the time period required to reach the target speed and the weight of the vehicle as the specification of the own-vehicle, and also using the vehicle speed and actual weight as the state of the vehicle. Based on a determination result, the vehicle groups are combined. That is, the vehicle group information is calculated using the distance between the other-vehicles when the own-vehicle reaches the same speed as the other-vehicles. Further, the vehicle group display apparatus 20 displays the image indicating the vehicle group corresponding to the vehicle group information calculated as above. In this manner, an effect can be obtained such that it is possible to calculate the vehicle group by considering the specification and state of the own-vehicle, and to display the calculated vehicle group to the driver. Thereby, an effect can be obtained such that it is possible to avoid presenting to the driver a space between the vehicle groups that the own- vehicle should not be entered in view of the specification and state of the own-vehicle, and to provide an appropriate vehicle group in accordance with the own-vehicle.

Note that, in the above description, although a case has been described where the vehicle group is calculated using the information from the own-vehicle information acquisition unit 102, the other-vehicle information management unit 104, and the own-vehicle specification acquisition unit 105, the present embodiment is not limited to this. It is sufficient as long as the vehicle group information is calculated using the distance between the other-vehicles based on the position information indicating the positions of the other-vehicles and the movement characteristic of the own-vehicle. The movement characteristic of the own-vehicle is a characteristic affecting the movement of the own-vehicle, and may use at least one of movement characteristics such as the information gathered by the own-vehicle information acquisition unit 102, and the information acquired by the own-vehicle specification acquisition unit 105.

For example, as a value of the movement characteristic of the own-vehicle, it is acceptable to use only the actual weight of the own-vehicle. In this case, for example, it is determined whether or not to combine the vehicle groups which are adjacent to each other by comparing an inter-vehicle group distance obtained from threshold value information with an actual inter-vehicle group distance, using the threshold value information indicating a relationship between the standard inter-vehicle group distance, that is, a threshold value of the inter-vehicle group distance and the actual weight of the own-vehicle. That is, the vehicle group is calculated using the threshold value information indicating the relationship between the value of the movement characteristic of the own-vehicle and the threshold value of the distance between the plurality of other-vehicles included in the same vehicle group. In this manner, as with the present embodiment, it is possible to calculate the vehicle group by considering the specification and state of the own-vehicle, and the same effect can be obtained.

Further, in the above description, a case has been described where the vehicle group calculation unit 106 determines whether or not to combine the calculated vehicle groups which are adjacent to each other, after calculating the standard vehicle group. However, the vehicle group information may be calculated using the distance between the other-vehicles and the movement characteristic of the own-vehicle, without calculating the standard vehicle group.

Further, in the above description, although details on how the vehicle information 2 reaches the own-vehicle a have not been described, any method is applicable such as one-to one communication with the other-vehicle, broadcast by the other-vehicle, or a collective transmission of pieces of vehicle information on a plurality of vehicles by a roadside apparatus capable of communicating with a representative vehicle and the vehicle group management apparatus 10.

Further, in the above description, the vehicle group calculation unit 106 calculates, in response to the arrival of the new vehicle information 2 at the other-vehicle information management unit 104, the inter-vehicle distance between the vehicles which are adjacent to each other based on the current position of each vehicle information. However, the vehicle group calculation unit 106 may periodically operate. For example, the vehicle group calculation unit 106 may operate in accordance with an update interval of the display unit 202. Thereby, the effect can be obtained such that unnecessary processing that is not actually displayed is prevented.

Further, in the above description, an elapsed time from the reception of the vehicle information 2 until the start of processing of the vehicle group calculation unit 106 has not been considered. However, since the position of the other-vehicle is changing during the elapsed time, positions of the calculated vehicle group and the actual other-vehicle are displaced. In order to solve this problem, the vehicle group calculation unit 106 may calculate a difference between the time when the calculation is started and the transmission time included in the vehicle information 2, and may correct the current position of the vehicle using the calculated difference and the vehicle speed included in the vehicle information 2. Thereby, an effect can be obtained such that the accuracy of the vehicle group calculation is improved. Note that, the vehicle information for past several times may be accumulated for each vehicle identifier in the other-vehicle information management unit 104, and may be used for correcting the current position of the other-vehicle. In this manner, an effect can be obtained such that it is possible to predict whether the vehicle is in an acceleration tendency or a deceleration tendency.

Further, in the above description, although only a lane to be merged has been focused and described, there might be two or more lanes in an actual road. In this case, a problem arises that if vehicles running in different lanes are included in the same vehicle group, no appropriate display is made with respect to an inter-vehicle distance in which merging is actually possible. In order to solve this problem, the vehicle group may be calculated on a lane-by-lane basis. Information on the lane may be, for example, acquired from the map data stored in the map screen production unit 108. In this manner, an effect can be obtained such that it is possible to appropriately display a space in which merging is possible.

Further, in the above description of FIG. 8, although the example is illustrated in which a figure surrounding each of the vehicle groups is overlaid and displayed on the map screen, the vehicle groups may be displayed in a different manner. For example, a space between the vehicle groups may be emphasized which is a candidate for the own-vehicle to enter when merging. In this case, the display information generation unit 107 generates image data in which spaces between vehicle groups of a plurality of vehicle groups are emphasized.

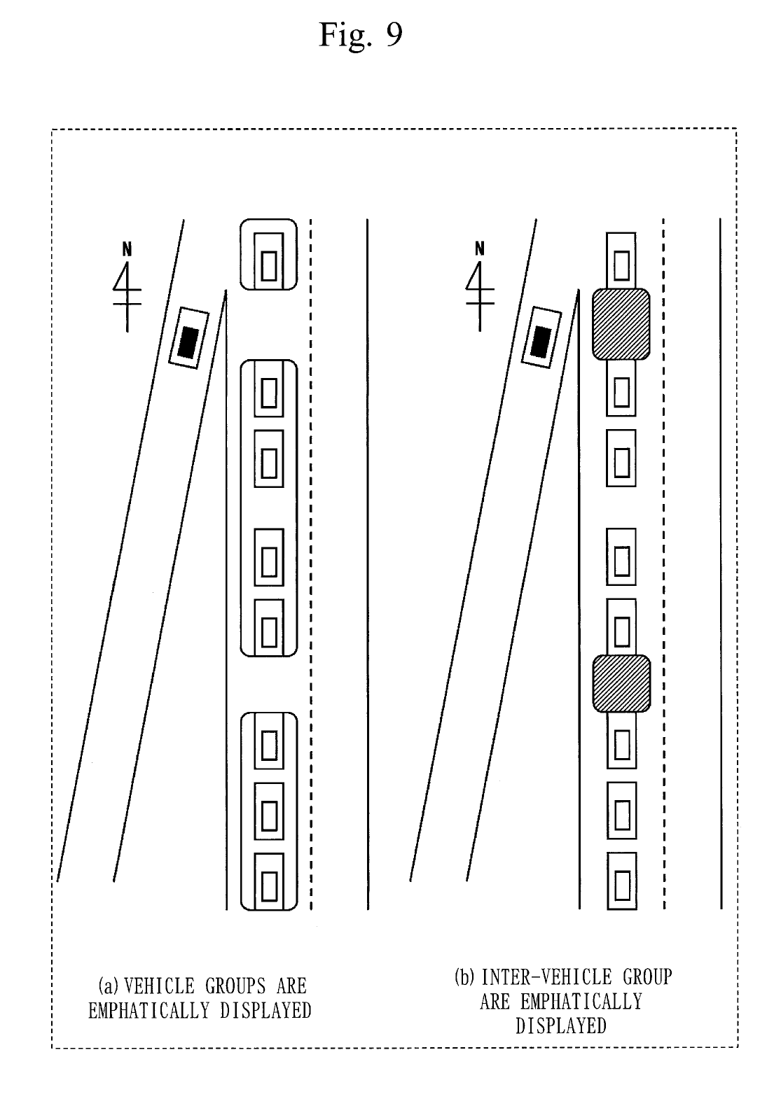

FIG. 9 is a diagram illustrating an example of image data displayed by the display unit 202 according to the present embodiment.

FIG. 9 (a) is the same as FIG. 8 (b), and the vehicle groups are emphatically displayed.

In FIG. 9 (b), the spaces between the vehicle groups are emphatically displayed with respect to FIG. 9 (a). Note that, images meaning the other-vehicles do not need to be actually displayed.

Further, in the above description, although each of the other-vehicles b to i runs individually, some of these other-vehicles may run in a formation. In such a case, even if there is a space, in which merging is possible, between the vehicles running in the formation, it is preferable to refrain from merging since the formation running is disturbed. In order to solve this problem, the vehicles running in the formation transmit data meaning a vehicle group, the vehicle group management apparatus 10 which has received that data may display the vehicle group calculated by the vehicle group calculation unit 106 and the received data meaning the vehicle group in a manner that distinguishes between the calculated vehicle group and the received data.

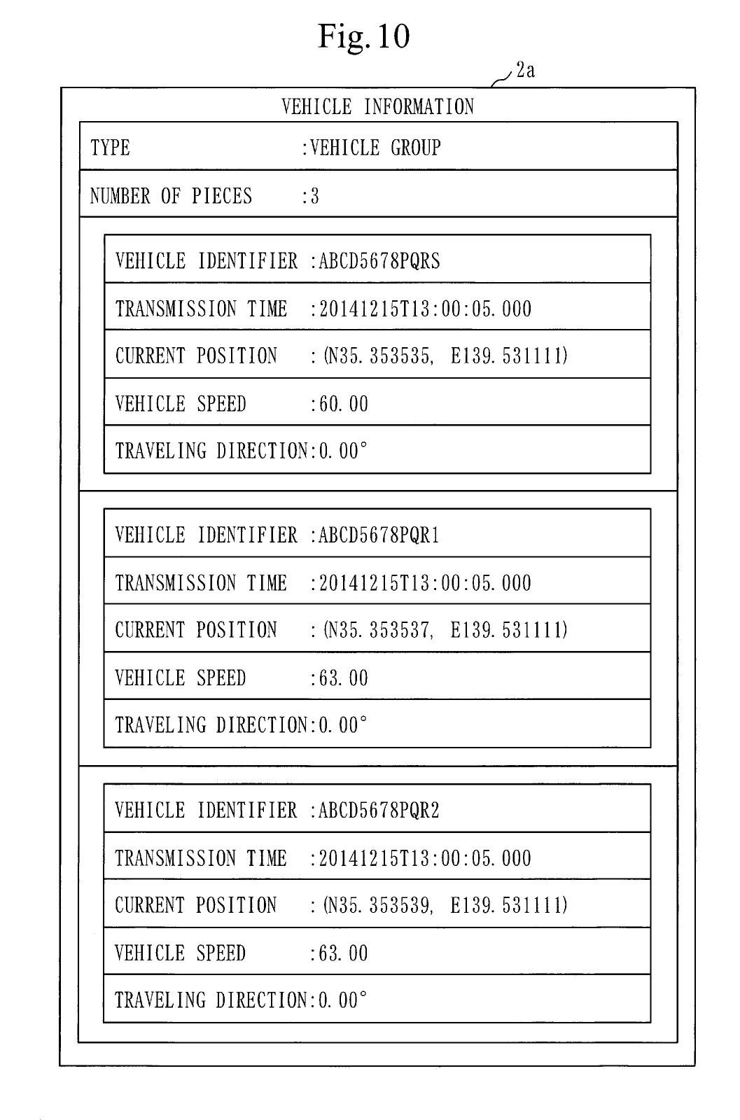

FIG. 10 illustrates a configuration of vehicle information 2a indicating vehicle groups. Although the configuration of the vehicle information 2a is the same as that of the vehicle information 2, it is different in that “vehicle group” indicating a vehicle group is in the type. Further, “3” is in the number of pieces, and corresponding to this three sets each of which has the items from the vehicle identifier to the traveling direction are included.

By doing as described above, an effect can be obtained such that it is possible for a driver of a vehicle on which the vehicle group management apparatus 10 is mounted to distinguish between a vehicle independently running individually and a vehicle group running in the formation.

Further, in FIG. 8, although all of the calculated vehicle groups are illustrated to be displayed in the same manner, priority may be set for each vehicle group and display and non-display may be switched or the degree of emphasis may be changed. A criterion of the priority includes, for example, raising the priority of a vehicle group approaching the own-vehicle, raising the priority of a space having a large inter-vehicle group distance, and the like. In this manner, an effect can be obtained such that it is possible to display the vehicle group or the space between the vehicle groups that should be preferentially watched in a way that enables the driver of the vehicle on which the vehicle group management apparatus 10 is mounted to easily recognize them.

Further, in the above description, although it is assumed that there is no other-vehicle on the same lane as the own-vehicle a, there is a case where an other-vehicle exists ahead of the own-vehicle a on the same lane as the own-vehicle a. In such a situation, if the other-vehicle on the same lane enters a lane to be merged, a space arises in which the own-vehicle a cannot enter. This is not considered in the above description. In order to solve this problem, the vehicle group management apparatus 10 may calculate the vehicle group while assuming that the other-vehicle on the same lane enters the lane to be merged, using the vehicle information 2 received from the other-vehicle on the same lane and using movement direction information on a movement direction such as the traveling direction included in the vehicle information 2. For example, in FIG. 4, in a case where one other-vehicle ahead of the own-vehicle a on the same lane as the own-vehicle a, the vehicle group is calculated based on an assumption that one more other-vehicle exists between the other-vehicle b and the other-vehicle c. In this manner, an effect can be obtained such that it is possible to predict a shape of the vehicle group on a lane after being merged affected by the existence of the other-vehicle on the same lane, so as to provide more appropriate information to the driver of the vehicle on which the vehicle group management apparatus 10 is mounted.

Further, in the above description, although the other-vehicles b to i move straight on the same lane, one or more other-vehicles might change a lane to a right lane (the right side of a dotted line in FIG. 4). In such a situation, the shape of the vehicle group is highly likely to change. Thus, movement direction information on a movement direction such as a state of a direct indicator may be added to the vehicle information 2, and thereby a schedule of changing lanes and turning to the right/left may be detected using that vehicle information 2 and may be reflected in calculation of the vehicle group and display contents. That is, the display information generation unit 107 may generate image data indicating, a case where the other-vehicles included in the vehicle group have different movement directions and a case where the other-vehicles included in the vehicle group have the same movement directions while varying in expression depending on each case. For example, a vehicle scheduled to change a lane or turn right/left may be excluded from the vehicle group to be calculated based on an assumption that the vehicle is in a lane different from a current lane at a time when the vehicle reaches the vicinity of the own-vehicle a. Also, only the vehicle may be emphatically displayed, or the display of a vehicle group to which the vehicle belongs may be changed so as to be different from that of the other-vehicle group. In this manner, an effect can be obtained such that it is possible to provide the driver of the vehicle on which the vehicle group management apparatus 10 is mounted, in more detail, with a space to which the vehicle is possible to enter when merging.

Further, in the above description, a case where the map screen production unit 108 is included has been described. However, in a case where the image data in which the vehicle group is overlaid and displayed on the map screen is not generated, for example, in a case where a map image is not included in figure data, the map screen production unit 108 may be removed.

Further, in the above description, a case where the display unit 202 is provided in the vehicle group display apparatus 20 has been described. However, the display unit 202 may be provided in the vehicle group management apparatus 10. Further, a case where the display information generation unit 107 is provided in the vehicle group management apparatus 10 has been described. However, the display information generation unit 107 may be provided in the outside of the vehicle group management apparatus 10, for example in the vehicle group display apparatus 20.

### Second Embodiment

With respect to the present embodiment, a difference from the first embodiment will be mainly described.

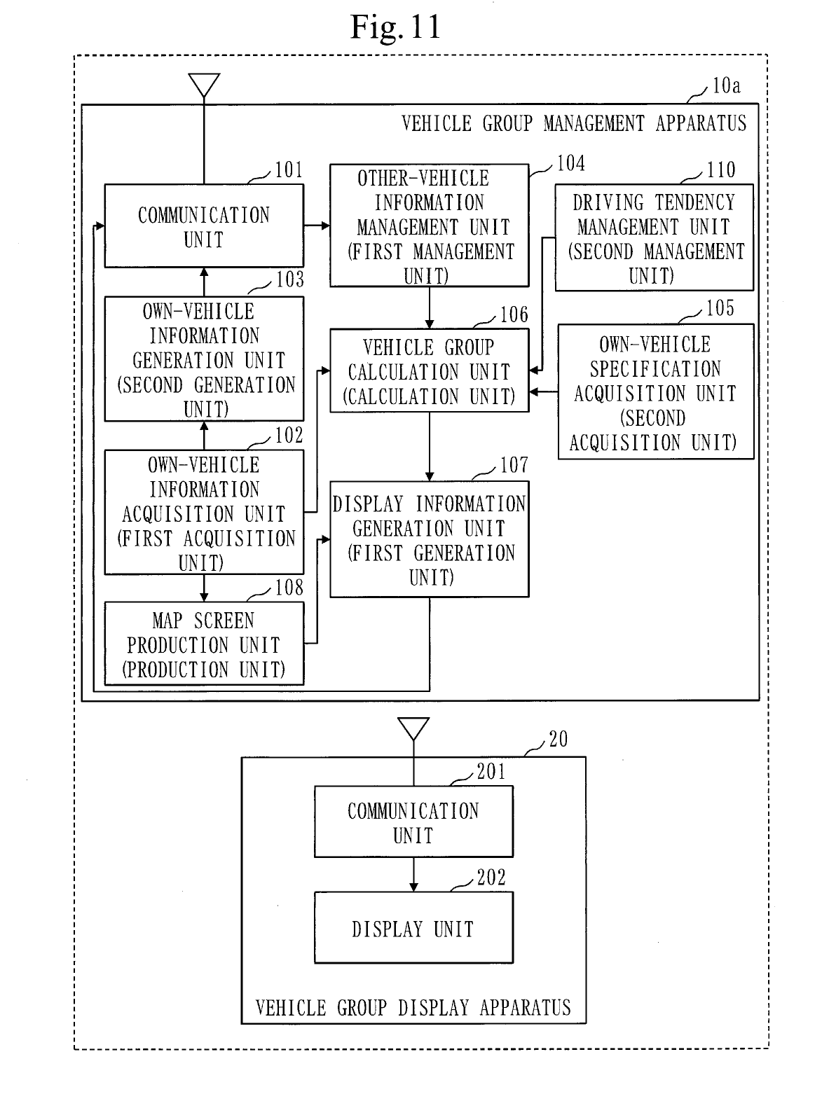

FIG. 11 is a configuration diagram illustrating an example of a vehicle group management apparatus 10a and the vehicle group display apparatus 20 according to a second embodiment indicating one embodiment of the present invention.

In FIG. 11, the vehicle group management apparatus 10a is configured by adding a driving tendency management unit 110 to the vehicle group management apparatus 10.

The driving tendency management unit 110 is a device that manages operation tendency information indicating an operation tendency of an operator of an own-vehicle. Here, the operator is a driver, and the operation tendency information indicating the operation tendency is a characteristic of the driver when merging and changing lanes. The driving tendency management unit 110 is a device that is possible to perform a driver identification about the driver and to store a characteristic of each driver when merging and changing lanes. Further, the driving tendency management unit 110 is realized by the storage device 302 illustrated in FIG. 2. Note that, the driving tendency management unit 110 corresponds to a second management unit.

Nextly, operations of the vehicle group management apparatus 10a and the vehicle group display apparatus 20 will be described, and processing operations of a vehicle group management method and a vehicle group management program will also be described.

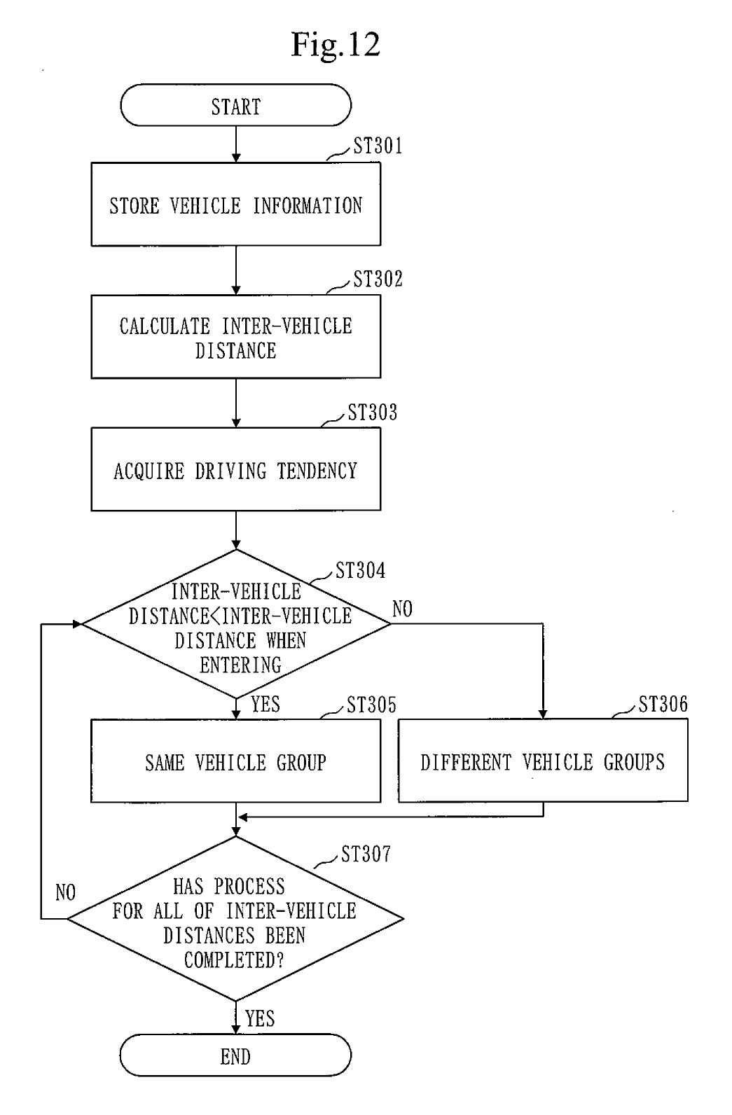

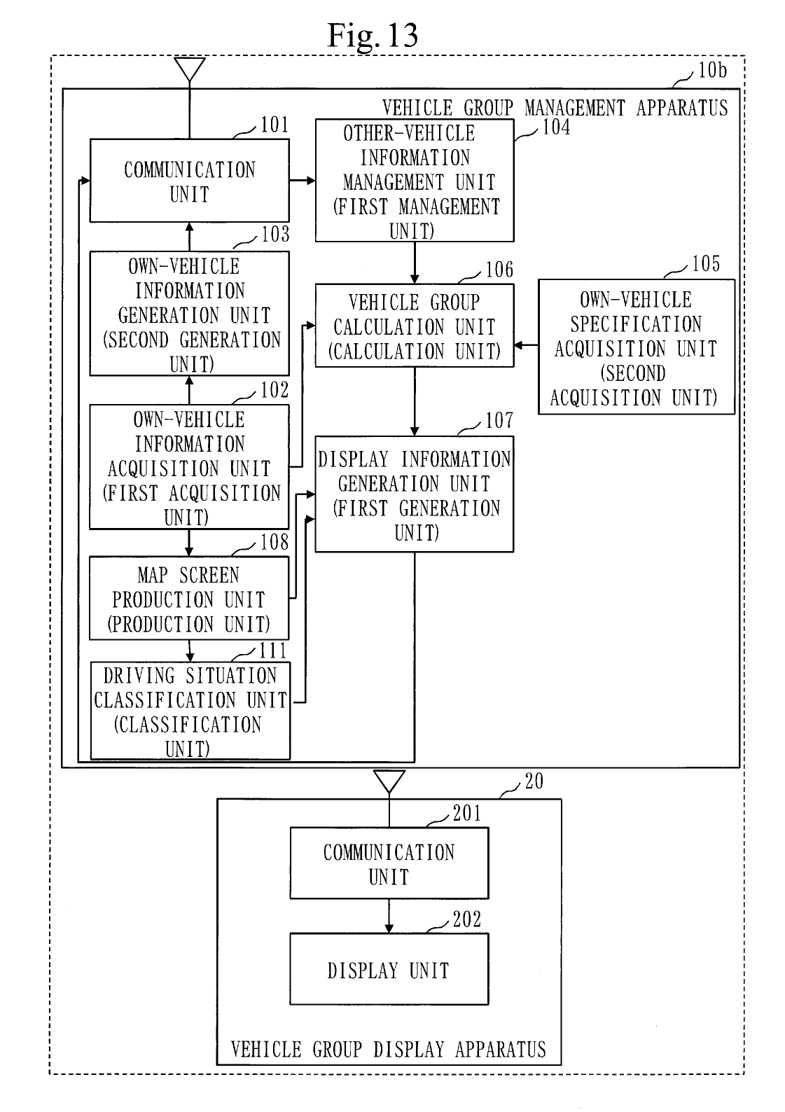

FIG. 12 is a flowchart illustrating an operation at a time when the vehicle group management apparatus 10a according to the present embodiment receives the vehicle information.

Note that, it is assumed that the driver identification has been completed by the driving tendency management unit 110 before starting to drive, and the description will be omitted. Further, in order to clarify the difference from the first embodiment, the description will be made by assuming that there is no process relating to the process of calculating the vehicle group using the specification and state of the own-vehicle.

(ST301): The same process as ST201 is performed.

(ST302): The same process as ST202 is performed.

(ST303): As a driving tendency of a current driver, the vehicle group calculation unit 106 acquires from the driving tendency management unit 110 a mean and variance of an inter-vehicle distance in a region the current driver has entered when merging. Further, a result obtained by subtracting the acquired variance from the acquired mean is defined as an inter-vehicle distance when entering.

(ST304): the vehicle group calculation unit 106 performs an iterative process from ST304 to ST307 for each inter-vehicle distance. In ST304, the vehicle group calculation unit 106 compares the inter-vehicle distance when entering calculated in ST303 with the inter-vehicle distance calculated in ST302. If the inter-vehicle distance is shorter (Yes), the process proceeds to ST305. In other cases (No), the process proceeds to ST306.

(ST305): The vehicle group calculation unit 106 generates or updates the vehicle group information 3 while assuming that two vehicles corresponding to the inter-vehicle distance of interest belong to the same vehicle group.

(ST306): The vehicle group calculation unit 106 generates the vehicle group information 3 by assuming that the two vehicles corresponding to the inter-vehicle distance of interest belong to different vehicle groups.

(ST307): The vehicle group calculation unit 106 checks whether the iterative process has been completed for all of inter-vehicle distances. If the process has been completed (Yes), the process ends. If the process has not been completed, the process of ST304 is started for a next inter-vehicle distance.

Note that, every time the own-vehicle on which the vehicle group management apparatus 10a is mounted executes merging, the driving tendency management unit 110 identifies the inter-vehicle distance in the space the own-vehicle has entered, and accumulates it in the driving tendency management unit 110. In parallel, the mean and variance are calculated and accumulated in the driving tendency management unit 110.

As described above, in the present embodiment, the vehicle group management apparatus 10a receives the vehicle information 2 using the communication unit 101, accumulates the vehicle information 2 in the other-vehicle information management unit 104. The vehicle group calculation unit 106 determines whether or not the vehicles which are adjacent to each other belong to the same vehicle group, based on the driving tendency of the driver, using information from the other-vehicle information management unit 104 and the driving tendency management unit 110, and calculates the vehicle group based on a determination result. That is, the vehicle group information is calculated using the operation tendency information indicating the operation tendency of the operator of the own-vehicle. Further, the vehicle group display apparatus 20 displays an image indicating the vehicle group corresponding to the vehicle information calculated as above. In this manner, an effect can be obtained such that it is possible to calculate and display the vehicle group reflecting the operation tendency of the operator such as the driver's ordinary driving.

Further, in the above description, although there is no process relating to the combination of the vehicle groups described in the first embodiment, that process may be combined with the process described in the present embodiment. Alternatively, operations may be performed such that when the number of pieces of data which forms a basis of the driving tendency of the driver is small in the driving tendency management unit 110, only the process described in the first embodiment is involved, and when the number of pieces of data which forms the basis of the driving tendency becomes large enough, only the process described in the present embodiment is involved.

Further, in the above description, although it is assumed that the driving tendency management unit 110 is a part of the vehicle group management apparatus 10a, the driving tendency management unit 110 may be provided as a device different from the vehicle group management apparatus 10a. For example, the driving tendency management unit 110 may be realized as an application on a smartphone. In this manner, an effect can be obtained such that it is possible to utilize the driving tendency even in a different vehicle. Further, the driving tendency management unit 110 may exist inside each of the vehicle group management apparatus 10a and the smartphone, and the driving tendency management units 110 may cooperate with each other. Furthermore, in a case where the driving tendency management unit 110 is provided outside the vehicle group management apparatus 10a, if the driving tendency management unit 110 stores the specification and the like of the vehicle a driver has driven in addition to the individual driving information, it is possible to process, at a time of driving a different vehicle, the driving tendency while considering a difference between the specifications of the vehicles. As a result, an effect can be obtained such that it is possible to calculate a more appropriate vehicle group for a vehicle which the driver is about to drive.

### Third Embodiment

With respect to the present embodiment, a difference from the first embodiment will be mainly described.

FIG. 13 is a configuration diagram illustrating an example of a vehicle group management apparatus 10b and the vehicle group display apparatus 20 according to a third embodiment indicating one embodiment of the present invention.

In FIG. 13, the vehicle group management apparatus 10b is configured by adding a driving situation classification unit 111 to the vehicle group management apparatus 10.

The driving situation classification unit 111 is a device that determines a current driving situation of an own-vehicle on which the vehicle group management apparatus 10b is mounted. Further, the driving situation classification unit 111 is realized by the storage device 302 and the arithmetic device 303 illustrated in FIG. 2. Note that, the driving situation classification unit 111 corresponds to a classification unit.

Nextly, operations of the vehicle group management apparatus 10b and the vehicle group display apparatus 20 will be described, and processing operations of a vehicle group management method and a vehicle group management program will also be described.

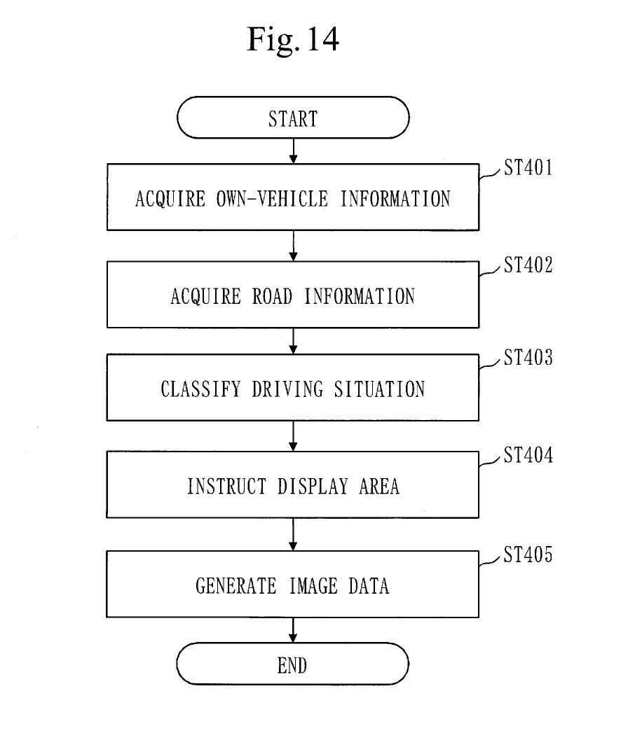

FIG. 14 is a flowchart illustrating an operation at a time when the vehicle group management apparatus 10b according to the present embodiment classifies the driving situation.

Note that, a process illustrated in FIG. 14 is executed periodically, and FIG. 14 illustrates the operation for one cycle.

(ST401): The driving situation classification unit 111 acquires from the own-vehicle information acquisition unit 102 information indicating a current position, a vehicle speed, a state of a direction indicator, and the like, as a state of the own-vehicle.

(ST402): The driving situation classification unit 111 acquires from the map screen production unit 108 a shape of a road around the own-vehicle.

(ST403): The driving situation classification unit 111 determines the driving situation using information acquired in ST401 and ST402. For example, the driving situation is such as merging, changing lanes, crossing, turning right, or turning left.

(ST404): The driving situation classification unit 111 instructs, depending on each situation, the display information generation unit 107 to set a display area of a vehicle group should be watched, to be displayed largely in the entire screen. For example, information associating the driving situation with the display area of the vehicle group should be watched is stored in the driving situation classification unit 111 in advance. Using this information, the driving situation classification unit 111 instructs the display information generation unit 107 to display the display area largely.

(ST405): The display information generation unit 107 generates, in accordance with the instruction from the driving situation classification unit 111, image data in which the display area of the vehicle group should be watched is displayed largely in the entire screen.

As described above, in the present embodiment, the vehicle group management apparatus 10b acquires, in the driving situation classification unit 111 from the own-vehicle information acquisition unit 102 and the map screen production unit 108, the state of the own-vehicle and the shape of the road around the own-vehicle, determines the driving situation based on the acquired information, and instructs, depending on each situation, the display information generation unit 107 to set the display area of the vehicle group should be watched, to be displayed largely in the entire screen. Further, the vehicle group display apparatus 20 displays the image indicating the vehicle group generated in accordance with this instruction. That is, the display information generation unit 107 generates the image data in which the display area of the vehicle group corresponding to the situation is displayed largely in the entire screen. In this manner, an effect can be obtained such that it is possible to display the display area of the vehicle group should be watched largely in the entire screen, and thereby the vehicle group can be easily seen by the driver.

Note that, in the above description, although a case has been described where the display area of the vehicle group should be watched is displayed largely in the entire screen, the display area of the vehicle group may be displayed small. Further, in order to display the display area of the vehicle group should be watched largely in the entire screen, an other-vehicle group may be displayed small.

### Fourth Embodiment

With respect to the present embodiment, a difference from the first embodiment will be mainly described.

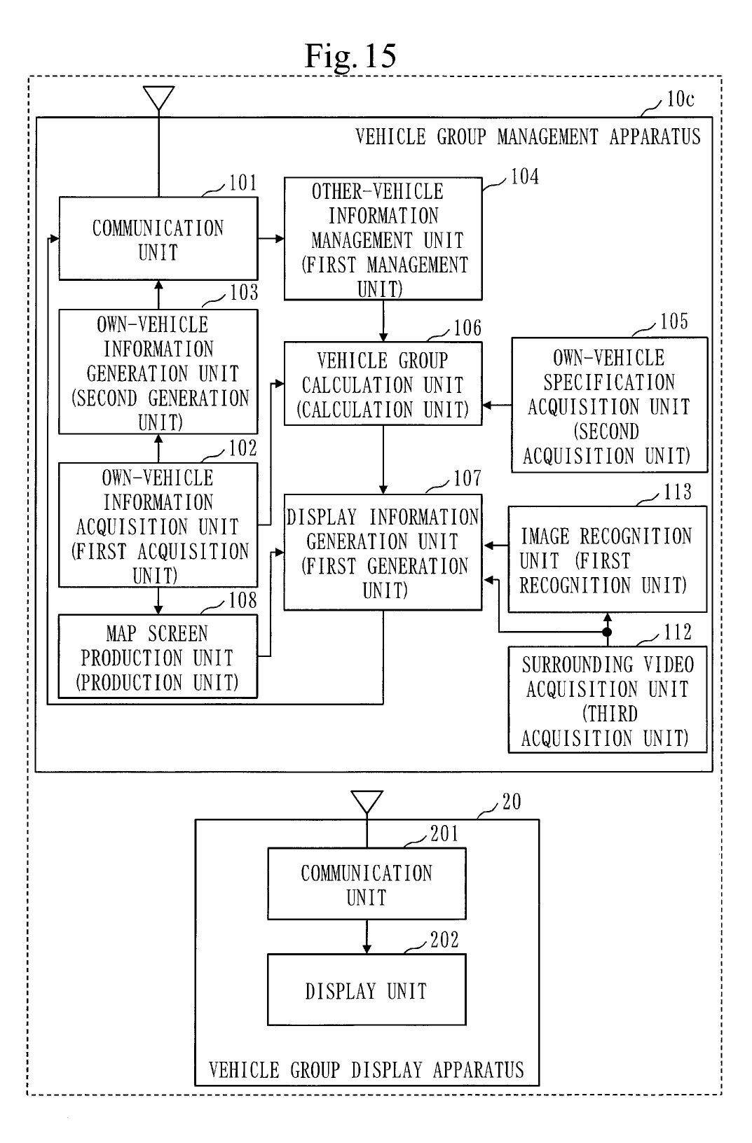

FIG. 15 is a configuration diagram illustrating an example of a vehicle group management apparatus 10c and the vehicle group display apparatus 20 according to a fourth embodiment indicating one embodiment of the present invention.

In FIG. 15, the vehicle group management apparatus 10c is configured by adding a surrounding video acquisition unit 112 and an image recognition unit to the vehicle group management apparatus 10.

The surrounding video acquisition unit 112 is a device that takes a video around a vehicle on which the vehicle group management apparatus 10c is mounted, and for example, is realized by a camera. Note that, the surrounding video acquisition unit 112 corresponds to a third acquisition unit.

The image recognition unit 113 is a device that recognizes a vehicle, a two-wheeled vehicle, a person, a road surface, and the like from a captured image acquired by the surrounding video acquisition unit 112. Further, the image recognition unit 113 is realized by the storage device 302 and the arithmetic device 303 illustrated in FIG. 2. Note that, the image recognition unit 113 corresponds to a first recognition unit.

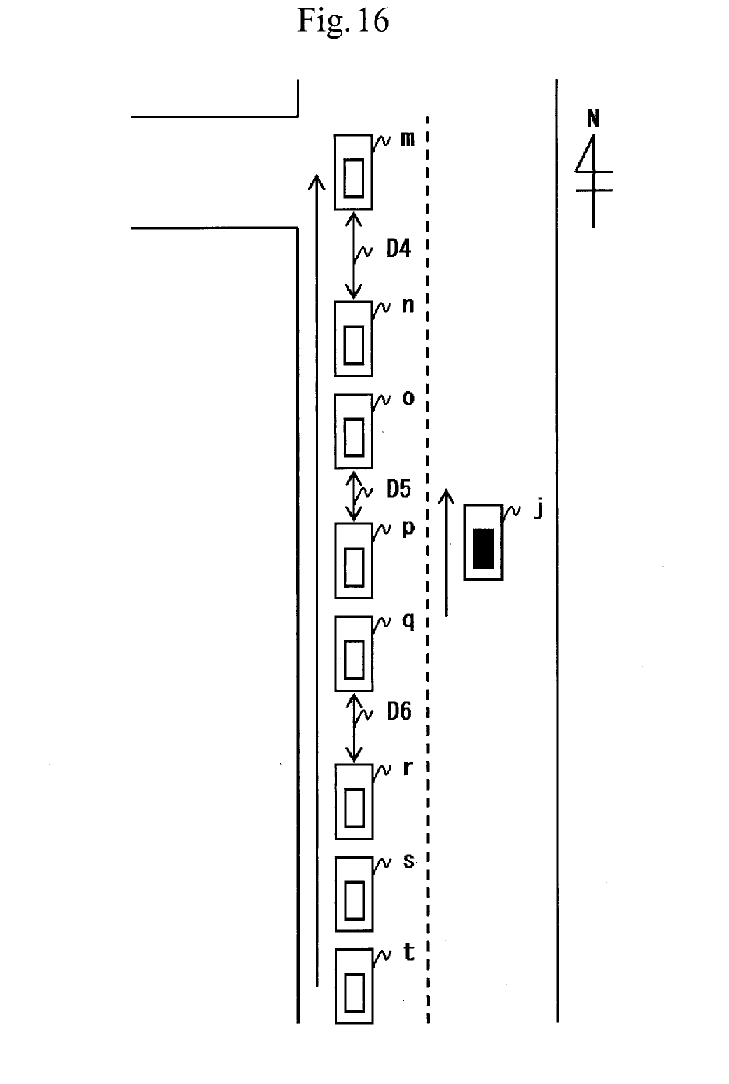

FIG. 16 is a diagram illustrating a positional relation between the own-vehicle and other-vehicles according to the present embodiment.

In FIG. 16, an arrow on the left side of other-vehicles m to t means traveling directions of an own-vehicle j and the other-vehicles m to t. Further, an inter-vehicle distance between the other-vehicle m and the other-vehicle n is D4, an inter-vehicle distance between the other-vehicle o and the other-vehicle p is D5, and an inter-vehicle distance between the other-vehicle q and the other-vehicle r is D6. That is, FIG. 16 illustrates a situation where the own-vehicle j and the other-vehicles m to t move in parallel. Note that, in the description below, it is assumed that each of the own-vehicle j and the other-vehicles m to t mounts the vehicle group management apparatus 10c.

Nextly, operations of the vehicle group management apparatus 10c and the vehicle group display apparatus 20 will be described, and processing operations of a vehicle group management method and a vehicle management program will also be described.

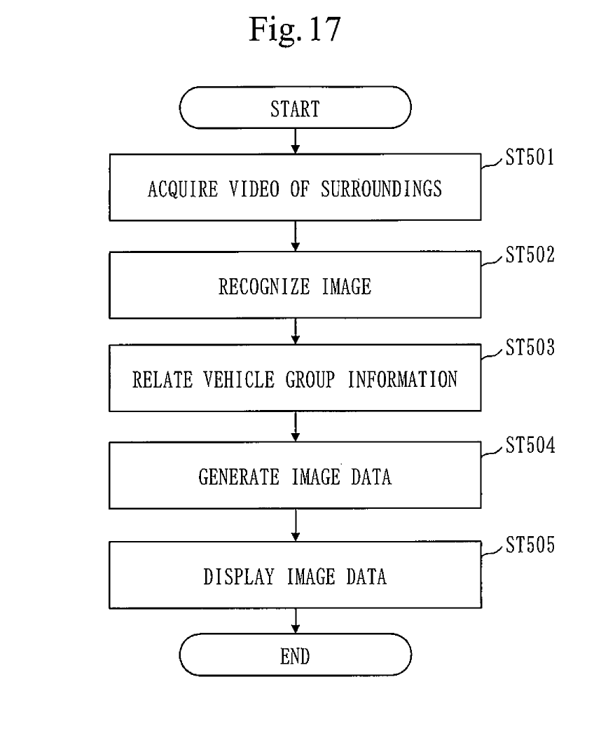

FIG. 17 is a flowchart illustrating an operation at a time when the vehicle group management apparatus 10c according to the present embodiment displays a vehicle group.

This operation is, for example, executed in synchronization with a screen switching cycle in the display unit 202. Note that, a process for calculating the vehicle group is the same as that in the first embodiment.

(ST501): The surrounding video acquisition unit 112 acquires a current position of the other-vehicle from the other-vehicle information management unit 104, and acquires a video in a direction where the other-vehicles exist.

(ST502): The image recognition unit 113 executes image recognition with respect to the captured image acquired in ST501, and calculates a position in the image where the vehicle is located.

(ST503): The display information generation unit 107 decides a correspondence relation between the calculation result of ST502 and the vehicle included in the vehicle group information 3, using a calculation result of ST502, an installation location of the surrounding video acquisition unit 112 acquired from the own-vehicle specification acquisition unit 105, the direction of the captured image acquired from the surrounding video acquisition unit 112, and the vehicle group information 3 acquired from the vehicle group calculation unit 106. For example, when the own-vehicle j takes an entire leftward video, it is considered that the other-vehicle p is at the position corresponding to the true left. Based on this, it is also possible to relate the calculation result of ST502 with the vehicle group information 5 acquired from the vehicle group calculation unit 106, as to adjacent vehicles in front of and behind the other-vehicle p.

(ST504): The display information generation unit 107 generates, based on the association in ST503, image data in which the vehicle group is overlaid on the captured image acquired from the surrounding video acquisition unit 112. For example, the display information generation unit 107 receives the map screen from the map screen production unit 108 and also receives the vehicle group information 3 from the vehicle group calculation unit 106. Then, display information generation unit 107 generates the image data in which the vehicle group is overlaid and displayed on the map screen, by collating information on a position in map data associated with that map screen with the current position of the vehicle included in the vehicle group included in the vehicle group information 3.

(ST505): The display unit 202 displays the image data generated in ST504.

As described above, in the present embodiment, in the vehicle group management apparatus 10c, the surrounding video acquisition unit 112 acquires the video in the direction where the other-vehicles exist, the image recognition unit 113 calculates, using the image recognition, a position in the image where the vehicle is located, and the display information generation unit 107 relates the vehicle group information 3 with the image recognition result and generates the image data in which the vehicle group is overlaid on the captured image. Then, the display unit 202 displays that image data. In this manner, an effect can be obtained such that it is possible to provide information in a form that is easy for a driver to intuitively understand.

Note that, in the above description, although the display unit 202 displays the entire video acquired by the surrounding video acquisition unit 112, a display range may be narrowed down. For example, the display range may be narrowed down to a range of the other-vehicles m to o on the left front of the own-vehicle j or of the other-vehicles q to ton the left rear of the own-vehicle j. In this manner, an effect can be obtained such that a place where the driver needs to pay attention is displayed more clearly.

Further, in the above description, although the vehicle group is overlaid on the captured video acquired by the surrounding video acquisition unit 112 and displayed, as described in the first embodiment, a display format that displays a space between vehicle groups with an emphasis can be adopted.

### Fifth Embodiment

With respect to the present embodiment, a difference from the first embodiment will be mainly described.

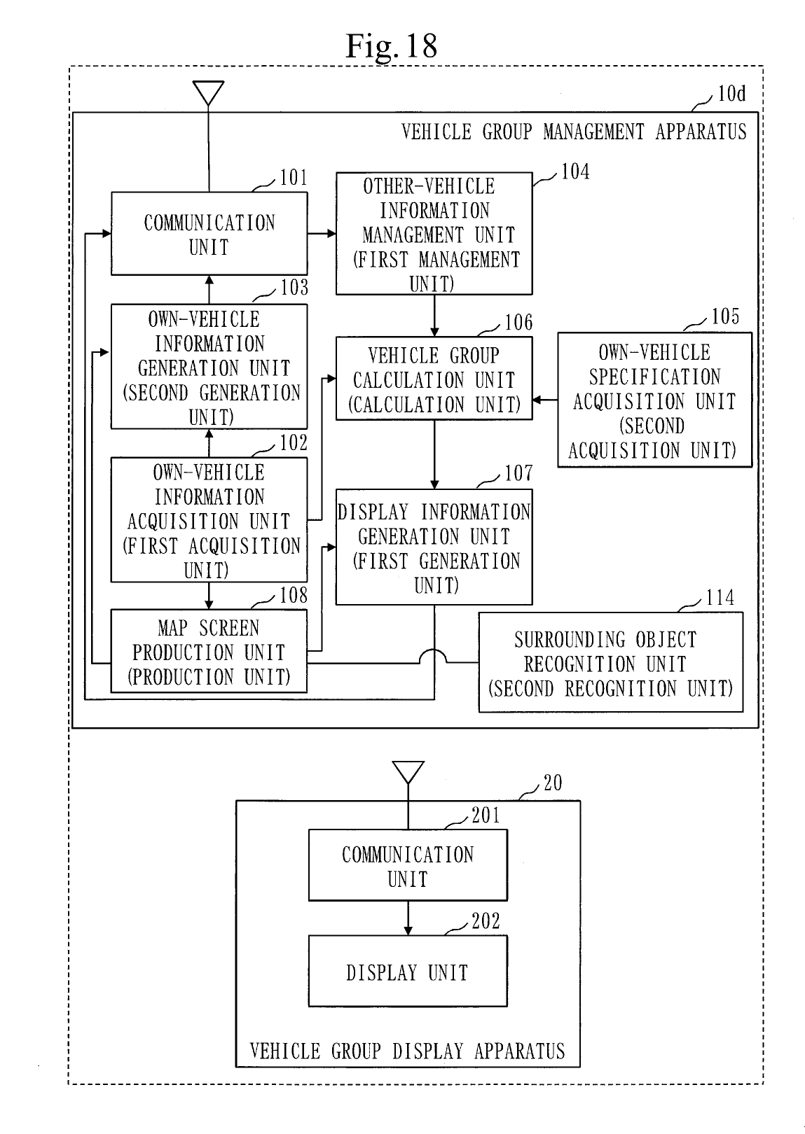

FIG. 18 is a configuration diagram illustrating an example of a vehicle group management apparatus 10d and the vehicle group display apparatus 20 according to a fifth embodiment indicating one embodiment of the present invention.

In FIG. 18, the vehicle group management apparatus 10d is configured by adding a surrounding object recognition unit 114 to the vehicle group management apparatus 10.

The surrounding object recognition unit 114 is a device that recognizes a vehicle, an obstacle, a pedestrian, and the like surrounding a vehicle on which the vehicle group management apparatus 10d is mounted, and calculates positions, relative speeds, movement directions and the like of those, from an amount of change with respect to time passage of a recognition result. The surrounding object recognition unit 114 is realized by configuring with a camera, a radar, and the like, and the arithmetic device 303 that processes data from those and the storage device 302. Note that, the surrounding object recognition unit 114 corresponds to a second recognition unit.

Nextly, operations of the vehicle group management apparatus 10d and the vehicle group display apparatus 20 will be described, and processing operations of a vehicle group management method and a vehicle management program will also be described.

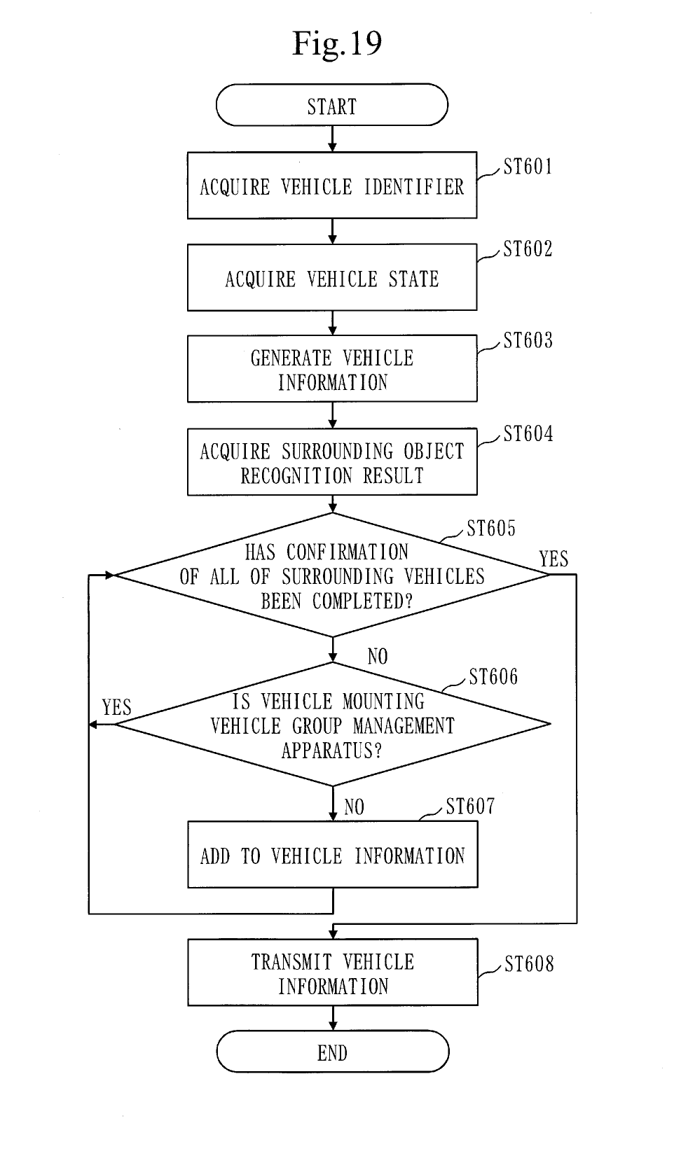

FIG. 19 is a flowchart illustrating an operation at a time when the vehicle group management apparatus 10d according to the present embodiment transmits the vehicle information 2.

(ST601): A process is the same as that of ST101 of FIG. 5.

(ST602): A process is the same as that of ST102 of FIG. 5.

(ST603): A process is the same as that of ST103 of FIG. 5.

(ST604): The own-vehicle information generation unit 103 acquires from the surrounding object recognition unit 114 a position, a movement direction, and a relative speed of a surrounding vehicle.

(ST605): The own-vehicle information generation unit 103 checks if a confirmation whether or not all of surrounding vehicles acquired in ST603 mount the vehicle group management apparatus has been completed. If the confirmation has been completed (Yes), the process proceeds to ST608. In other cases (No), the process proceeds to ST606.

(ST606): The own-vehicle information generation unit 103 compares the position of the surrounding vehicle acquired in ST603 with the position of the other-vehicle accumulated in the other-vehicle information management unit 104, and if a difference between them is less than a predetermined value (Yes), it is interpreted that the vehicle has the vehicle group management apparatus 10d and the process proceeds to ST605. In other cases (No), it is interpreted that the vehicle does not have the vehicle group management apparatus 10d. That is, it is interpreted that the vehicle does not notify the other-vehicle of its position, and the process proceeds to ST607.

(ST607): The own-vehicle information generation unit 103 adds to the vehicle information 2 the information on the other-vehicle checked in ST606. At this time, nothing is set for the vehicle identifier, a value set in ST603 is set as it is for the transmission time, the position acquired in ST604 is set for the current position, a result obtained by adding the vehicle speed of the own-vehicle acquired in ST602 to the relative speed acquired in ST604 is set for the vehicle speed, and a value acquired in ST604 is set for the traveling direction. Further, the number of pieces in the vehicle information 2 is increased by 1.

(ST608): The communication unit 101 transmits the vehicle information 2 generated in ST607.

As described above, in the present embodiment, using the information on the surrounding vehicle acquired by the surrounding object recognition unit 114 and the vehicle information 2 accumulated in the other-vehicle information management unit 104, the vehicle group management apparatus 10d determines whether or not the surrounding vehicle has the vehicle group management apparatus 10d. The vehicle group management apparatus 10d transmits the vehicle information 2 to which the information on the vehicle that does not have the vehicle group management apparatus 10d is added. That is, the own-vehicle information generation unit 103 generates the vehicle information including the position information indicating the position of the other-vehicle existing in the vicinity of the own-vehicle. By doing this, an effect can be obtained such that it is possible for the own-vehicle that has received that vehicle information 2 to calculate, even in a situation where the vehicle that does not have the vehicle group management apparatus 10d exists, the vehicle group with the same accuracy as in a situation where all the vehicles that exist have the vehicle group management apparatus 10d.

Further, in the above description, a case is not considered where pieces of the vehicle information 2 on the same vehicle are transmitted from a plurality of other-vehicles. Therefore, a problem may occur in which the number of vehicles referred to at a time of calculating the vehicle group is larger than the number of vehicles that actually exist. With respect to this problem, the other-vehicle information management unit 104 of the vehicle group management apparatus 10d may calculate a distance between respective vehicles may be calculated for a vehicle for which the vehicle identifier has not been set, and if the distance is less than a fixed value, the other-vehicle information management unit 104 may regard the vehicles as the same vehicle. By doing this, an effect can be obtained such that the vehicle to be referred to at the time of calculating the vehicle group is closer to an actual situation. Note that, as described in the first embodiment, it may be considered that each vehicle might have moved during a period corresponding to the difference between the transmission time of the vehicle information 2 and a starting time of the process described herein.

Further, in the above description, although the contents displayed by the display unit 202 are not mentioned, the display contents of the vehicle group may vary depending on the number and proportion of the vehicles that do not have the vehicle group management apparatus 10d belonging to each vehicle group. By doing this, an effect can be obtained such that it is possible to notify the driver of the vehicle on which the vehicle group management apparatus 10d is mounted that there exists the vehicle that does not have the vehicle group management apparatus 10d.

Further, in the above description, although it is assumed that the vehicle group management apparatus 10d transmits the information on the own-vehicle and the information on the surrounding vehicle collectively as one vehicle information 2, they may be transmitted individually.

Note that, the configurations described in a plurality of above embodiments may be appropriately combined within the scope of the purpose of the invention.

### INDUSTRIAL APPLICABILITY

As described above, the vehicle group management apparatus, the vehicle group management method, the vehicle group management program, and the vehicle group display apparatus according to the present invention are, for example, suitable for application to those that manage the plurality of vehicles moving in line as the vehicle group.

### REFERENCE SIGNS LIST

10, 10a, 10b, 10c, 10d: vehicle group management apparatus; 101: communication unit; 102: own-vehicle information acquisition unit (first acquisition unit); 103: own-vehicle information generation unit (second generation unit); 104: other-vehicle information management unit (first management unit); 105: own-vehicle specification acquisition unit (second acquisition unit); 106: vehicle group calculation unit (calculation unit); 107: display information generation unit (first generation unit); 108: map screen production unit (production unit); 110: driving tendency management unit (second management unit); 111: driving situation classification unit (classification unit); 112: surrounding video acquisition unit (third acquisition unit); 113: image recognition unit (first recognition unit); 114: surrounding object recognition unit (second recognition unit); 20: vehicle group display apparatus; 201: communication unit; 202: display unit; 301: communication device; 302: storage device; 303: arithmetic device; 304: CAN; 305: communication device; 306: storage device; 307: arithmetic device; 308: display; 2: vehicle information, and 3: vehicle group information.

1-16. (canceled)

17. A vehicle group display apparatus comprising:
processing circuitry to:
receive image data indicating a vehicle group including at least one of other-vehicles, the vehicle group being specified in accordance with a distance between the other-vehicles that are a plurality of other-vehicles moving in line and a movement characteristic of an own-vehicle; and
display the image data received.

18. The vehicle group display apparatus according to claim 17,
wherein, in the image data, a space between vehicle groups among a plurality of vehicle groups is emphasized.

19. The vehicle group display apparatus according to claim 17,
wherein, in the image data, a display area of the vehicle group corresponding to a situation is indicated largely or small in an entire screen.

20. The vehicle group display apparatus according to claim 17,
wherein, the image data indicates a case where the other-vehicles included in the vehicle group have different movement directions and a case where the other-vehicles included in the vehicle group have same movement directions, while varying in expression depending on each case.

21. The vehicle group display apparatus according to claim 17,
wherein, in the image data, the vehicle group is overlaid on a video image of the other-vehicles.

22. A vehicle group management apparatus comprising:
processing circuitry to:
manage vehicle information including position information indicating a position of an other-vehicle included in a plurality of other-vehicles moving in line and movement information on a movement of the other-vehicle;
acquire speed information indicating a speed of an own-vehicle;
acquire, as a specification indicating static performance of the own-vehicle, acceleration specification information indicating a time period required to reach a target vehicle speed from a current vehicle speed; and
calculate vehicle group information indicating a vehicle group including the other-vehicle by calculating a distance between other-vehicles when a speed of the own-vehicle reaches a same speed as the other-vehicle, the distance being a distance between the other-vehicle and an other-vehicle which moves in line with the other-vehicle, using a distance between the other-vehicles based on the position information, the speed information on the own-vehicle, the acceleration specification information on the own-vehicle, and the movement information on the other-vehicle.

23. The vehicle group management apparatus according to claim 22,
wherein the acceleration specification information on the own-vehicle further indicates a specification weight of the own-vehicle, and
wherein the processing circuitry calculates the distance between the other-vehicles when the speed of the own-vehicle reaches the same speed as the other-vehicle, using the speed information on the own-vehicle, the acceleration specification information on the own-vehicle, the movement information on the other-vehicle, and an actual weight of the own-vehicle.

24. The vehicle group management apparatus according to claim 22,
wherein the processing circuitry calculates the vehicle group information using threshold value information indicating a relationship between a value of the movement characteristic of the own-vehicle and a threshold value of the distance between a plurality of other-vehicles included in the same vehicle group.

25. The vehicle group management apparatus according to claim 22,
wherein the processing circuitry manages operation tendency information indicating an operation tendency of an operator of the own-vehicle, and
calculates the vehicle group information using the operation tendency information.

26. The vehicle group management apparatus according to claim 22,
wherein the vehicle information includes movement direction information on a movement direction of the other-vehicle, and
wherein the processing circuitry calculates the vehicle group information using the movement direction information.

27. The vehicle group management apparatus according to claim 22,
wherein the vehicle information includes formation information indicating that a plurality of other-vehicles are moving in a formation, and
wherein the processing circuitry calculates the vehicle group information using the formation information.

28. The vehicle group management apparatus according to claim 22,
wherein the processing circuitry generates, using the vehicle group information calculated, image data indicating the vehicle group.

29. The vehicle group management apparatus according to claim 22,
wherein the processing circuitry generates vehicle information including position information indicating a position of the own-vehicle, and
transmits to the other-vehicle the vehicle information generated.

30. The vehicle group management apparatus according to claim 29,
wherein the processing circuitry generates vehicle information including position information indicating a position of an other-vehicle existing in vicinity of the own-vehicle.

31. A vehicle group management method comprising:
managing vehicle information including position information indicating a position of an other-vehicle included in a plurality of other-vehicles moving in line and movement information on a movement of the other-vehicle;
acquiring speed information indicating a speed of an own-vehicle;
acquiring, as a specification indicating static performance of the own-vehicle, acceleration specification information indicating a time period required to reach a target vehicle speed from a current vehicle speed; and
calculating vehicle group information indicating a vehicle group including the other-vehicle by calculating a distance between other-vehicles when a speed of the own-vehicle reaches a same speed as the other-vehicle, the distance being a distance between the other-vehicle and an other-vehicle which moves in line with the other-vehicle, using a distance between the other-vehicles based on the position information, the speed information on the own-vehicle, the acceleration specification information on the own-vehicle, and the movement information on the other-vehicle.

32. A non-transitory computer readable medium storing a vehicle group management program that causes a computer to execute:
a first management process to manage vehicle information including position information indicating a position of an other-vehicle included in a plurality of other-vehicles moving in line and movement information on a movement of the other-vehicle;
a first acquisition process to acquire speed information indicating a speed of an own-vehicle;
a second acquisition process to acquire, as a specification indicating static performance of the own-vehicle, acceleration specification information indicating a time period required to reach a target vehicle speed from a current vehicle speed; and
a calculation process to calculate vehicle group information indicating a vehicle group including the other-vehicle by calculating a distance between other-vehicles when a speed of the own-vehicle reaches a same speed as the other-vehicle, the distance being a distance between the other-vehicle and an other-vehicle which moves in line with the other-vehicle, using a distance between the other-vehicles based on the position information, the speed information on the own-vehicle, the acceleration specification information on the own-vehicle, and the movement information on the other-vehicle.
